(19) United States
(12) Patent Application Publication
(10) Pub. No.: US 2020/0056051 A1
(43) Pub. Date: Feb. 20, 2020

(54) CURABLE RESIN COMPOSITION FOR OPTICAL FILMS, OPTICAL FILM AND METHOD FOR PRODUCING SAME

(71) Applicant: NITTO DENKO CORPORATION, Ibaraki-shi, Osaka (JP)

(72) Inventor: Takeshi Saito, Ibaraki-shi (JP)

(73) Assignee: NITTO DENKO CORPORATION, Ibaraki-shi, Osaka (JP)

(21) Appl. No.: 16/346,946

(22) PCT Filed: Nov. 8, 2017
(86) PCT No.: PCT/JP2017/040256

§ 371 Date: May 2, 2019

(30) Foreign Application Priority Data
Nov. 22, 2016 (JP) 2016-226920
Oct. 18, 2017 (JP) 2017-201764

(51) Int. Cl. C09D 4/06; C09D 135/02; C08J 7/04; B32B 27/36; B32B 27/30; B32B 27/08; G02B 5/30; G02B 1/14

(52) U.S. Cl. CPC C09D 4/06; C09D 135/02; C08J 7/047; B32B 27/36; B32B 27/308; B32B 27/08; B32B 2255/10; G02B 1/14; C08J 2329/04; C08J 2435/02; C08J 2423/28; B32B 2255/26; G02B 5/305

(57) ABSTRACT

A curable resin composition for optical films comprises an active-energy-ray-curable component (A) and a chlorinated polyolefin (B). It is preferred that the chlorinated polyolefin (B) has a chlorine content of 25 to 50% by weight. It is also preferred that a ratio by weight of the active-energy-ray-curable component (A) to the chlorinated polyolefin (B) is from 100/1 to 100/40.

### TECHNICAL FIELD

The present invention relates to a curable resin composition for optical films; an optical film in which a cured product layer of the curable resin composition for optical films is laminated on at least one surface of a polyvinyl alcohol based polarizer; and a method for producing the optical film. This optical film can be configured to form an image display such as a liquid crystal display (LCD), an organic EL display, a CRT, or a PDP.

### BACKGROUND ART

In watches, portable telephones, PDAs, notebook PCs, monitors for personal computers, DVD players, TVs and others, liquid crystal displays have been rapidly developing in the market. A liquid crystal display is a display making the state of polarized light visible by switching of a liquid crystal. In light of the display principle thereof, a polarizer is used. In particular, TVs and other articles have been increasingly required to be higher in brightness and contrast, and wider in viewing angle. Their polarizing film has also been increasingly required to be higher in transmittance, polarization degree, color reproducibility, and others.

As a polarizer, an iodine based polarizer has been most popularly and widely used, which has a structure obtained by adsorbing iodine onto, for example, a polyvinyl alcohol (hereinafter also referred to merely as a “PVA”), and then stretching the resultant, since this polarizer has a high transmittance and a high polarization degree. A generally used polarizing film is a polarizing film in which transparent protective films are bonded, respectively, onto both surfaces of a polarizer through the so-called water based adhesive, in which a polyvinyl alcohol based material is dissolved in water (Patent Document 1 listed below). For the transparent protective films, for example, triacetylcellulose is used, which has a high moisture permeability. In the case of the use of the water based adhesive (the so-called wet lamination), a drying step is required after the transparent protective films are bonded to the polarizer.

Instead of the water based adhesive, an active-energy-ray-curable adhesive is suggested. When the active-energy-ray-curable adhesive is used to produce polarizing films, no drying step is required. Thus, the polarizing films can be improved in producibility. For example, the inventors have suggested a radical polymerizable active-energy-ray-curable adhesive, using an N-substituted amide based monomer as a curable component (Patent Document 2 listed below.

### PRIOR ART DOCUMENTS

### Patent Documents

Patent Document 1: JP-A-2001-296427

Patent Document 2: JP-A-2012-052000

### SUMMARY OF THE INVENTION

### Problems to be Solved by the Invention

An adhesive layer formed using the active-energy-ray-curable adhesive described in Patent Document 2 can sufficiently pass, for example, a water resistance test in which after the layer is immersed in hot water of 60° C. temperature for 6 hours, it is judged whether or not the layer is discolored or peeled off. However, in recent years, adhesives for optical films have been required to have such a further improved water resistance that the adhesives can pass, for example, a severer water resistance test in which after an object bonded through any one of the adhesives is immersed in water (or saturated with water), it is judged whether or not this object is peeled off in the case of attempting to peel off an end of the object with nails. In the actual circumstances, therefore, about adhesives for optical films that have been reported up to the present time, which include the active-energy-ray-curable adhesive described in Patent Document 2, there is a room for a further improvement in water resistance thereof.

As described above, the market has been requesting optical films to have higher optical endurance, and has been requesting optical films to show a less change in optical endurance, in particular, optical property under severe humidifying conditions, for example, conditions of 85° C. temperature and 85% RH. Active-energy-ray-curable adhesives are better also in optical endurance than water-based adhesives. In the present situation, however, about active-energy-ray-curable adhesives known in the prior art, there remains a room for a further improvement in the endurance.

In the light of the actual situation, the present invention has been made. An object thereof is to provide a curable resin composition for optical films which is used for optical films each including at least a polyvinyl alcohol based polarizer, and which allows to form a cured product layer excellent in optical endurance even in a dew condensation environment, or under severe conditions such that this layer is immersed in water.

Another object of the present invention is to provide an optical film which includes a polyvinyl alcohol based polarizer, and a cured product layer of the curable resin composition for optical films that is laminated on at least one surface of the polarizer; and which is excellent in optical endurance.

### Means for Solving the Problems

In order to solve the above-mentioned problems, the inventors have investigated the following when a cured product layer, such as an adhesive layer, is laminated on a polyvinyl alcohol based polarizer: the dyeability of the cured product layer which results from an iodine compound derived from the polarizer. As a result, the inventors have found out that the problems can be solved by adding a specified component into the cured product layer, and laminating the cured product layer directly onto the polyvinyl alcohol based polarizer.

Accordingly, the present invention relates to a curable resin composition for optical films which includes an active-energy-ray-curable component (A) and a chlorinated polyolefin (B).

It is preferred in the curable resin composition for optical films that the chlorinated polyolefin (B) has a chlorine content of 25 to 50% by weight.

It is preferred in the curable resin composition for optical films that a ratio by weight of the active-energy-ray-curable component (A) to the chlorinated polyolefin (B) is from 100/1 to 100/40.

The present invention also relates to an optical film including a polyvinyl alcohol based polarizer, and a cured product layer of a curable resin composition for optical films which includes an active-energy-ray-curable component (A) and a chlorinated polyolefin (B), this cured product layer being laminated on at least one surface of the polarizer.

It is preferred in the optical film that a transparent protective film is laminated over the at least one surface of the polyvinyl alcohol based polarizer to interpose the cured product layer between the surface and the transparent protective film.

It is preferred that the optical film is a film in which the cured product layer is laminated on the one surface of the polyvinyl alcohol based polarizer, and a transparent protective film is laminated on/over the other surface of the polyvinyl alcohol based polarizer.

Furthermore, the present invention relates to a method for producing an optical film including a polyvinyl alcohol based polarizer and a cured product layer that is on at least one surface of the polyvinyl alcohol based polarizer and that is yielded by curing a curable resin composition for optical films; the curable resin composition for optical films that includes an active-energy-ray-curable component (A) and a chlorinated polyolefin (B); and the method including an applying step of applying the curable resin composition for optical films directly onto the at least one surface of the polyvinyl alcohol based polarizer, and a curing step of radiating an active energy ray to the resultant from a polyvinyl-alcohol-based-polarizer-surface side of the resultant or a side of the resultant onto which the curable resin composition for optical films is applied, so as to cure the curable resin composition for optical films.

### Effect of the Invention

A polyvinyl alcohol based polarizer is usually produced by wet- or dry-stretching polyvinyl alcohol uniaxially, and then dyeing the resultant with an iodine compound and crosslinking the resultant with a crosslinking agent. In the case of incorporating an active-energy-ray-curable component (A) and a chlorinated polyolefin (B) into a curable resin composition which is to constitute a cured product layer, the resultant cured product layer is remarkably lowered in dyeability resulting from an iodine compound derived from the polyvinyl alcohol based polarizer, so that this layer functions as a protective layer for restraining the release/diffusion of the iodine compound from the polarizer. As a result, when the curable resin composition according to the present invention is used for an optical film having at least a polyvinyl alcohol based polarizer, in particular, for a polarizing film, this optical film, in particular, this polarizing film is remarkably improved in optical endurance.

As described above, the cured product layer of the curable resin composition for optical films according to the present invention is remarkably low in dyeability resulting from an iodine compound derived from the polyvinyl alcohol based polarizer, so that this layer functions effectively as a protective layer for the polyvinyl alcohol based polarizer. Accordingly, the optical film according to the invention is excellent in optical endurance even when no transparent protective film is laminated on/over the polyvinyl alcohol based polarizer. Moreover, even in the case of laminating, in the optical film according to the invention, a transparent protective film by use of the cured product layer as an adhesive layer, the adhesive layer functions effectively as a protective layer so that the optical film is excellent in optical endurance in spite of the species of the transparent protective film.

### MODE FOR CARRYING OUT THE INVENTION

The curable resin composition for optical films according to the present invention includes an active-energy-ray-curable component (A) and a chlorinated polyolefin (B).

<Active-Energy-Ray-Curable Component (A)>

The active-energy-ray-curable component (A) usable in the present invention can be roughly classified into an electron curable, an ultraviolet curable or a visible ray curable component. About the form of the curing of the composition, the composition can be divided into a radical polymerization curable resin composition or a cation polymerizable resin composition. In the present invention, active energy rays having a wavelength in the range of 10 nm or more, and less than 380 nm are referred to as ultraviolet rays, and active energy rays having a wavelength in the range of 380 to 800 nm are referred to as visible rays. In particular, the active-energy-ray-curable component (A) usable in the present invention is especially preferably a visible ray curable component, which uses visible rays of 380 to 450 nm wavelengths.

<1: Radical Polymerization Curable Compound>

The radical polymerizable compound may be a compound having a radical polymerizable functional group of a carbon-carbon double bond, such as a (meth)acryloyl group or a vinyl group. Such a curable component may be any one of monofunctional radical polymerizable compounds, and bi- or higher polyfunctional radical polymerizable compounds. These radical polymerizable compounds may be used singly or in any combination of two or more thereof. These radical polymerizable compounds are each preferably, for example, a compound having a (meth)acryloyl group. In the present invention, the wording “(meth)acryloyl” means an acryloyl group and/or a methacryloyl group. The notation “(meth)a” has the same or similar meaning hereinafter. The compound having a (meth)acryloyl group may be any (meth)acrylamide derivative having a (meth)acrylamide group, or any (meth)acrylate having a (meth)acryloyloxy group. Examples of the compound having a (meth)acryloyl group will be described hereinafter. However, the compound is selectable from various compounds to be usable; thus, the compound is not particularly limited. The content of the radical polymerizable compound in the active-energy-ray-curable resin composition of the present invention is preferably 10% or more by weight.

<<Monofunctional Radical Polymerizable Compound>>

The monofunctional radical polymerizable compound is, for example, a compound represented by the following general formula (1):

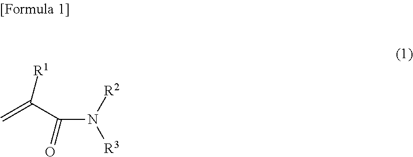

wherein R¹ is a hydrogen atom or a methyl group, and R² and R³ are each independently a hydrogen atom, or an alkyl, hydroxyalkyl, alkoxyalkyl or cyclic ether group, and R² and R³ may form a cyclic heterocycle. The number of carbon atoms in the alkyl moiety of (each of) the alkyl, hydroxyalkyl, and/or alkoxyalkyl group(s) is not particularly limited, and is, for example, from 1 to 4. The cyclic heterocycle, which R² and R³ may form, includes, for example, a N-acryloylmorpholine.

Specific examples of the compound represented by the general formula (1) include N-methyl(meth)acrylamide, N,N-dimethyl(meth)acrylamide, N,N-diethyl(meth)acrylamide, N-isopropyl(meth)acrylamide, N-butyl(meth)acrylamide, N-hexyl(meth)acrylamide, and other N-alkyl-group-containing (meth)acrylamide derivatives; N-methylol(meth)acrylamide, N-hydroxyethyl(meth)acrylamide, N-methylol-N-propane(meth)acrylamide, and other N-hydroxyalkyl-group-containing (meth)acrylamide derivatives; and N-methoxymethylacrylamide, N-ethoxymethylacrylamide, and other N-alkoxy-group-containing (meth)acrylamide derivatives. The cyclic-ether-group-containing (meth)acrylamide derivative is, for example, a heterocycle-containing (meth)acrylamide derivative in which a nitrogen atom of a (meth)acrylamide group is configured to form a heterocycle. Examples thereof include N-acryloylmorpholine, N-acryloylpiperidine, N-methacryloylpiperidine, and N-acryloylpyrrolidine. Out of these examples, N-hydroxyethylacrylamide and N-acryloylmorpholine are preferred since these compounds are excellent in reactivity and can each give a cured product with a high elastic modulus, and the resultant adhesive layer is excellent in adhesion to a polarizer.

From the viewpoint of an improvement of a polarizer and the curable resin layer in adhesion therebetween and in water resistance, in particular, from the viewpoint of an improvement in the adhesion and the water resistance when the polarizer and a transparent protective film are adhered to each other through the adhesive layer, and the viewpoint of an improvement of the resultant optical films in producibility, this improvement resulting from a high polymerization rate of the polymerizable compound, the content of the compound represented by the general formula (1) in the curable resin composition is preferably from 1 to 50%, more preferably from 3 to 20% by weight. If the content of the compound represented by the general formula (1) is especially too large, the cured product may be heightened in water absorption coefficient to be deteriorated in water resistance.

The curable resin composition used in the present invention may contain, besides the compound represented by the general formula (1), a different monofunctional radical polymerizable compound as a curable component. Examples of the monofunctional radical polymerizable compound include various (meth)acrylic acid derivatives each having a (meth)acryloyloxy group. Specific examples thereof include methyl (meth)acrylate, ethyl (meth)acrylate, n-propyl (meth)acrylate, isopropyl (meth)acrylate, 2-methyl-2-nitropropyl (meth)acrylate, n-butyl (meth)acrylate, isobutyl (meth)acrylate, s-butyl (meth)acrylate, t-butyl (meth)acrylate, n-pentyl (meth)acrylate, t-pentyl (meth)acrylate, 3-pentyl (meth)acrylate, 2,2-dimethylbutyl (meth)acrylate, n-hexyl (meth)acrylate, cetyl (meth)acrylate, n-octyl (meth)acrylate, 2-ethylhexyl (meth)acrylate, 4-methyl-2-propylpentyl (meth)acrylate, n-octadecyl (meth)acrylate, and other (C₁ to C₂₀) alkyl (meth)acrylates.

Examples of the above-mentioned (meth)acrylic acid derivatives include cyclohexyl (meth)acrylate, cyclopentyl (meth)acrylate, and other cycloalkyl (meth)acrylates; benzyl (meth)acrylate, and other aralkyl (meth)acrylates; 2-isobornyl (meth)acrylate, 2-norbornylmethyl (meth)acrylate, 5-norbornene-2-yl-methyl (meth)acrylate, 3-methyl-2-norbornylmethyl (meth)acrylate, dicyclopentenyl (meth)acrylate, dicyclopentenyloxyethyl (meth)acrylate, dicyclopentanyl (meth)acrylate, and other polycyclic (meth)acrylates; and 2-methoxyethyl (meth)acrylate, 2-ethoxyethyl (meth)acrylate, 2-methoxymethoxyethyl (meth)acrylate, 3-methoxybutyl (meth)acrylate, ethylcarbitol (meth)acrylate, phenoxyethyl (meth)acrylate, alkylphenoxy polyethylene glycol (meth)acrylate, and other alkoxy-group- or phenoxy-group-containing (meth)acrylates. When the resin composition of the present invention is used for an adhesive for polarizing films, the composition preferably contains an alkoxy-group- or phenoxy-group-containing (meth)acrylate, such as phenoxyethyl (meth)acrylate or an alkylphenoxy polyethylene glycol (meth)acrylate from the viewpoint of a close adhesion of the adhesive layer to a protective film. The content of the radical polymerizable compound is preferably from 1 to 30% by weight of the resin composition.

Examples of the above-mentioned (meth)acrylic acid derivatives include 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and other hydroxyalky (meth)acrylates; [4-(hydroxymethyl)cyclohexyl]methyl acrylate, cyclohexanedimethanol mono(meth)acrylate, 2-hydroxy-3-phenoxypropyl (meth)acrylate, and other hydroxyl-group-containing (meth)acrylates; glycidyl (meth)acrylate, 4-hydroxybutyl (meth)acrylate glycidyl ether, and other epoxy-group-containing (meth)acrylates; 2,2,2-trifluoroethyl (meth)acrylate, 2,2,2-trifluoroethyethyl (meth)acrylate, tetrafluoropropyl (meth)acrylate, hexafluoropropyl (meth)acrylate, octafluoropentyl (meth)acrylate, heptadecafluorodecyl (meth)acrylate, 3-chloro-2-hydroxypropyl (meth)acrylate, and other halogen-containing (meth)acrylates; dimethylaminoethyl (meth)acrylate, and other alkylaminoalkyl (meth)acrylates; 3-oxetanylmethyl (meth)acrylate, 3-methyl-oxetanylmethyl (meth)acrylate, 3-ethyl-oxetanylmethyl (meth)acrylate, 3-butyl-oxetanylmethyl (meth)acrylate, 3-hexyl-oxetanylmethyl (meth)acrylate, and other oxetane-group-containing (meth)acrylates; tetrahydrofurfuryl (meth)acrylate, butyrolactone (meth)acrylate, and other heterocycle-having (meth)acrylates; and a (meth)acrylic acid adduct of neopentylglycol hydroxypivalate, and p-phenylphenol (meth)acrylate. Out of these examples, 2-hydroxy-3-phenoxypropyl acrylate is preferred since the adhesive layer is excellent in adhesion to various protective films.

Examples of the monofunctional radical polymerizable compound include (meth)acrylic acid, carboxyethyl acrylate, carboxypentyl acrylate, itaconic acid, maleic acid, fumaric acid, crotonic acid, isocrotonic acid, and other carboxyl-group-containing monomers.

Other examples of the monofunctional radical polymerizable compound include N-vinylpyrrolidone, N-vinyl-ε-caprolactam, methylvinylpyrrolidone, and other lactam-based vinyl monomers; vinylpyridine, vinylpiperidone, vinylpyrimidine, vinylpiperazine, vinylpyrazine, vinylpyrrole, vinylimidazole, vinyloxazole, vinylmorpholine, and other vinyl monomers each having a nitrogen-containing heterocycle.

In the case of incorporating, into the resin composition, for example, a hydroxyl-group-containing (meth)acrylate, carboxyl-group-containing (meth)acrylate or phosphate-group-containing (meth)acrylate, which is high in polarity, out of the above-mentioned compounds, the resultant cured product layer is improved in adhesion in various substrates. The content of the hydroxyl-group-containing (meth)acrylate is preferably from 1 to 30% by weight of the resin composition. If the content is too large, the cured product may become high in water absorption coefficient to be deteriorated in water resistance. The content of the carboxyl-group-containing (meth)acrylate is preferably from 1 to 20% by weight of the resin composition. If the content is too large, the polarizing film is unfavorably lowered in optical endurance. The phosphate-group-containing (meth)acrylate is, for example, 2-(meth)acryloyloxyethyl acid phosphate. The content thereof is preferably from 0.1 to 10% by weight of the resin composition. If the content is too large, the polarizing film is unfavorably lowered in optical endurance.

The monofunctional radical polymerizable compound may also be a radical polymerizable compound having an active methylene group. The radical polymerizable compound having an active methylene group is a compound having, at a terminal thereof or in the molecule thereof, an active double bond group such as a (meth)acryl group, and further having an active methylene group. Examples of the active methylene group include acetoacetyl, alkoxymalonyl, and cyanoacetyl groups. The active methylene group is preferably an acetoacetyl group. Specific examples of the radical polymerizable compound having an active methylene group include 2-acetoacetoxyethyl (meth)acrylate, 2-acetoacetoxypropyl (meth)acrylate, 2-acetoacetoxy-1-methylethyl (meth)acrylate, and other acetoacetoxyalkyl (meth)acrylates; and 2-ethoxymalonyloxyethyl (meth)acrylate, 2-cyanoacetoxyethyl (meth)acrylate, N-(2-cyanoacetoxyethyl)acrylamide, N-(2-propionylacetoxybutyl)acrylamide, N-(4-acetoacetoxymethylbenzyl)acrylamide, and N-(2-acetoacetylaminoethyl)acrylamide. The radical polymerizable compound having an active methylene is preferably an acetoacethoxyalkyl (meth)acrylate.

<<Polyfunctional Radical Polymerizable Compound>>

Examples of the bi- or higher polyfunctional radical polymerizable compound include N,N′-methylenebis(meth)acrylamide, which is a polyfunctional (meth)acrylamide derivative, tripropylene glycol di(meth)acrylate, tetraethylene glycol di(meth)acrylate, 1,6-hexanediol di(meth)acrylate, 1,9-nonanediol di(meth)acrylate, 1,10-decanediol diacrylate, 2-ethyl-2-butylpropanediol di(meth)acrylate, bisphenol A di(meth)acrylate, bisphenol A ethylene oxide adduct di(meth)acrylate, bisphenol A propylene oxide adduct di(meth)acrylate, bisphenol A diglycidyl ether di(meth)acrylate, neopentyl glycol di(meth)acrylate, tricyclodecanedimethanol di(meth)acrylate, cyclic trimethylolpropaneformal (meth)acrylate, dioxane glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, EO-modified diglycerin tetra(meth)acrylate, and other esterified products each made from (meth)acrylic acid and a polyhydric alcohol; and 9,9-bis[4-(2-(meth)acryloyloxyethoxy)phenyl]fluorene. Preferred and specific examples thereof include ARONIX M-220 (manufactured by Toagosei Co., Ltd.), LIGHT ACRYLATE 1,9 ND-A (manufactured by Kyoeisha Chemical Co., Ltd.), LIGHT ACRYLATE DGE-4A (manufactured by Kyoeisha Chemical Co., Ltd.), LIGHT ACRYLATE DCP-A (manufactured by Kyoeisha Chemical Company, Ltd.), SR-531 (manufactured by a company Sartomer), and CD-536 (manufactured by the company Sartomer). As the need arises, for example, the following are used: various epoxy (meth)acrylates, urethane (meth)acrylates, polyester (meth)acrylates, and various (meth)acrylate based monomers. A polyfunctional (meth)acrylamide derivative is preferably incorporated into the curable resin composition since the derivative gives a high polymerization rate to give an excellent producing performance, and further at the time of making the resin composition into a cured product the derivative gives an excellent crosslinking performance.

About such radical polymerizable compounds, the monofunctional radical polymerizable compound and the polyfunctional radical polymerizable compound are preferably used together with each other in order to make the following compatible with each other: adhesion of the resultant layer to a polarizer and various transparent protective films; and the optical endurance of the resultant optical film in a severe environment. The monofunctional radical polymerizable compound is relatively low in liquid viscosity; thus, by incorporating the monofunctional radical polymerizable compound into the resin composition, the resin composition can be lowered in liquid viscosity. The monofunctional radical polymerizable compound has functional groups for expressing various functions in many cases. Thus, by incorporating the monofunctional radical polymerizable compound into the resin composition, the resin composition and/or a cured product of the resin composition can be caused to express various functions. The polyfunctional radical polymerizable compound can crosslink a cured product of the resin composition three-dimensionally. Thus, it is preferred to incorporate this compound into the resin composition. About the ratio between the monofunctional radical polymerizable compound and the polyfunctional radical polymerizable compound, it is preferred to blend an amount ranging from 10 to 1000 parts by weight of the polyfunctional radical polymerizable compound with 100 parts by weight of the monofunctional radical polymerizable compound.

<2. Cation Polymerization Curable Resin Composition>

The cation polymerizable compound used in the cation polymerization curable resin composition is classified into a monofunctional cation polymerizable compound, which has in the molecule thereof a single cation polymerizable functional group, or a polyfunctional cation polymerizable compound, which has in the molecule thereof two or more cation polymerizable functional groups. The monofunctional cation polymerizable compound is relatively low in liquid viscosity; thus, when this compound is incorporated into the resin composition, the resin composition can be lowered in liquid viscosity. Moreover, in many cases, the monofunctional cation polymerizable compound has functional groups for expressing various functions. Thus, the incorporation of this compound into the resin composition can cause various functions to be expressed in the resin composition and/or a cured product of the resin composition. The polyfunctional cation polymerizable compound makes it possible to crosslink the cure product of the resin composition three-dimensionally. Thus, this compound is preferably incorporated into the resin composition. About the ratio between the monofunctional cation polymerizable compound and the polyfunctional cation polymerizable compound, the latter is preferably blended into the former in an amount of 10 to 1000 parts by weight for 100 parts by weight of the former. The cation polymerizable functional group may be an epoxy, oxetanyl or vinyl ether group. Examples of a compound having this epoxy group include aliphatic epoxy compounds, alicyclic epoxy compounds, and aromatic epoxy compounds. The cation polymerization curable resin composition of the present invention in particular preferably contains an alicyclic epoxy compound since the composition is excellent in curability and adhesion. Examples of the alicyclic epoxy compound include 3,4-epoxycyclohexylmethyl-3,4-epoxycyclohexane carboxylate, and caprolactone-modified products, trimethyl caprolactone modified products or valerolactone-modified products of 3,4-epoxycyclohexylmethyl-3,4-epoxycyclohexane carboxylate. Specific examples thereof include products CELLOXIDE 2021, CELLOXIDE 2021A, CELLOXIDE 2021P, CELLOXIDE 2081, CELLOXIDE 2083, CELLOXIDE 2085 (each manufactured by Daicel Corporation); and CYRACURE UVR-6105, CYRACURE UVR-6107, CYRACURE 30, and R-6110 (each manufactured by Dow Chemical Japan Ltd.). It is preferred to incorporate a compound having the above-mentioned oxetanyl group into the cation polymerizable curable resin composition of the present invention since the compound has advantageous effects of improving the composition in curability and lower the composition in liquid viscosity. Examples of the oxetanyl-group-having compound include 3-ethyl-3-hydroxymethyloxetane, 1,4-bis[(3-ethyl-3-oxetanyl)methoxymethyl]benzene, 3-ethyl-3-(phenoxymethyl)oxetane, di[(3-ethyl-3-oxetanyl)methyl]ether, 3-ethyl-3-(2-ethylhexyloxymethyl)oxetane, and phenol novolac oxetane. The following are commercially available: products ARON OXETANE OXT-101, ARON OXETANE OXT-121, ARON OXETANE OXT-211, ARON OXETANE OXT-221, and ARON OXETANE OXT-212 (each manufactured by Toagosei Co., Ltd.). The compound having the above-mentioned vinyl ether group has an effect of improving the cation polymerization curable resin composition in curability or lowering the composition in liquid viscosity; thus, this compound is preferably incorporated into the composition. Examples of the vinyl-ether-group-having compound include 2-hydroxyethyl vinyl ether, diethylene glycol monovinyl ether, 4-hydroxybutyl vinyl ether, diethylene glycol monovinyl ether, triethylene glycol divinyl ether, cyclohexanedimethanol divinyl ether, cyclohexanedimethanol monovinyl ether, tricyclodecane vinyl ether, cyclohexyl vinyl ether, methoxyethyl vinyl ether, ethoxyethyl vinyl ether, and pentaerythritol type tetravinyl ether.

The curable resin composition for optical films according to the present invention includes a chlorinated polyolefin (B) together with the active-energy-ray-curable component (A).

<Chlorinated Polyolefin (B)>

The curable resin composition according to the present invention needs to be optically transparent in order to be used for optical films. Thus, it is important to select, as its polyolefin based resin, a chlorinated polyolefin (B) which is soluble in the active-energy-ray-curable component (A) and does not cause the composition to undergo layer separation nor precipitation. A polyolefin not chlorinated is not preferred since this polyolefin is remarkably lower in solubility in the compound (A), which is cured by irradiation with an active energy ray.

The chlorinated polyolefin (B) used in the present invention may be, for example, chlorinated polyethylene, chlorinated polypropylene, or acryl-modified or urethane-modified chlorinated polyolefin (B).

The chlorine content in the chlorinated polyolefin (B) is preferably from 25 to 50% by weight, more preferably from 30 to 45% by weight. If the content is lower than 25% by weight, the polyolefin is lowered in solubility in the compound (A), which is cured by irradiation with an active energy ray, so that an optically transparent composition may not be easily formed. If the content is more than 50% by weight, at the time of making the composition into a polarizing film this film may be largely changed in optical properties under severe conditions not to gain the advantageous effects of the present invention. The chlorine content in the chlorinated polyolefin (B) is measurable in accordance with JIS-K7229. More specifically, the content is measurable by, for example, the “oxygen-flask combustion method”, which is a method of combusting a chlorine-containing resin in an oxygen atmosphere, absorbing generated gaseous chlorine into water, and then determining the content quantitatively by titration.

The weight-average molecular weight of the chlorinated polyolefin (B) ranges preferably from 3,000 to 100,000, more preferably from 5,000 to 80,000, most preferably from 10,000 to 20,000. If the molecular weight of the chlorinated polyolefin (B) is too low, at the time of making the active-energy-ray-curable composition into a cured product, this product may not be sufficiently improved in water resistance. If the molecular weight is too high, the compound (B) may be remarkably lowered in solubility in the compound (A), which is cured by irradiation with an active energy ray. Thus, an optically transparent composition may not be easily formed.

Examples of the chlorinated polyolefin (B) obtainable as a commercially available product include include products SUPERCHLON series (manufactured by Nippon Paper Chemicals Co., Ltd.), HARDLEN series (manufactured by Toyobo Co., Ltd.), and ERASUREN series (manufactured by Showa Denko K.K.).

Out of products obtainable as commercially available products, the following are more preferably usable: products “SUPERCHLON 814HS”, “SUPERCHLON 390S”, “SUPERCHLON 3228S”, “SUPERCHLON 803MW”, “SUPERCHLON 803L” and “SUPERCHLON B” of the SUPERCHLON series (manufactured by Nippon Paper Chemicals Co., Ltd.); “HARDLEN 16-LP”, “HARDLEN 15-LP” and “HARDLEN CY-9124P” of the HARDLEN series (manufactured by Toyobo Co., Ltd.); and “ERASUREN 404B” “ERASUREN 402B” and “ERASUREN 401A” of the ERASUREN series (manufactured by Showa Denko K.K.). The “SUPERCHLON 814HS” is in particular preferably usable since the product is excellent in balance between the solubility thereof in the compound (A), which is cured by irradiation with an active energy ray, and the stability of optical properties of a polarizing film under severe humidifying conditions when this product is used to form the polarizing film.

In the curable resin composition for optical films, the ratio by weight of the compound (A), which is cured by irradiation with an active energy ray, to the chlorinated polyolefin (B) is preferably from 100/1 to 100/40. If the proportion by weight of the chlorinated polyolefin (B) is too small, the resultant optical film may increase in change of optical properties, which are advantageous effects of the present invention, under severe humidifying conditions. In the meantime, if the proportion by weight of the chlorinated polyolefin (B) is too large, the compound (B) is lowered in compatibility with the compound (A), which is cured by irradiation with an active energy ray, so that a optically transparent active-energy-ray-curable resin composition may be unable to be formed. The ratio by weight of the compound (A), which is cured by irradiation with an active energy ray, to the chlorinated polyolefin (B) is more preferably from 100/3 to 100/30, most preferably from 100/5 to 100/15.

<Embodiments of Radical Polymerization Curable Resin Composition>

The curable resin composition for optical films according to the present invention can be referred to also as an active-energy-ray-curable resin composition. When an electron beam or the like is used as an active energy ray for the active-energy-ray-curable resin composition, this active-energy-ray-curable resin composition does not need to contain any photopolymerization initiator. However, when an ultraviolet ray or visible ray is used as the active energy ray, the composition preferably contains a photopolymerization initiator.

<<Photopolymerization Initiator>>

The photopolymerization initiator when the above-mentioned radical polymerizable compound is used is appropriately selected in accordance with the active energy ray. When the compound is cured by an ultraviolet ray or visible ray, an ultraviolet or visible-ray-cleavable photopolymerization initiator is used. Examples of this photopolymerization initiator include benzyl, benzophenone, benzoyl benzoic acid, 3,3′-dimethyl-4-methoxybenzophenone, and other benzophenone based compounds; 4-(2-hydroxyethoxy)phenyl (2-hydroxy-2-propyl) ketone, α-hydroxy-α,α′-dimethylacetophenone, 2-methyl-2-hydroxypropiophenone, α-hydroxycyclohexyl phenyl ketone, and other aromatic ketone compounds; methoxyacetophenone, 2,2-dimethoxy-2-phenylacetophenone, 2,2-diethoxyacetophenone, 2-methyl-1-[4-(methylthio)-phenyl]-2-morpholinopropane-1, and other acetophenone based compounds; benzoin methyl ether, benzoin ethyl ether, benzoin isopropyl ether, benzoin butyl ether, anisoin methyl ether, and other benzoin ether based compounds; benzyl dimethyl ketal, and other aromatic ketal based compounds; 2-naphthalenesulfonyl chloride, and other aromatic sulfonyl chloride based compounds; 1-phenone-1,1-propanedione-2-(o-ethoxycarbonyl) oxime, and other optically active oxime based compounds; thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, dodecylthioxanthone, and other thioxanthone based compounds; camphorquinone; halogenated ketones; and acylphosphinoxide; and acylphosphonate.

The blend amount of the photopolymerization initiator is 20% or less by weight of the whole of the curable resin composition. The blend amount of the photopolymerization initiator is preferably from 0.01 to 20%, more preferably from 0.05 to 10%, even more preferably from 0.1 to 5% by weight of the composition.

When the curable resin composition used in the present invention is used as a visible ray curable composition including, as a curable component thereof, a radical polymerizable compound, it is preferred to use a photopolymerization initiator high in sensitivity, particularly, to light rays of 380 nm or more wavelength. About the photopolymerization initiator high in sensitivity to light rays of 380 nm or more wavelength, a description will be made later.

It is preferred to use, as the photopolymerization initiator, a compound represented by the following general formula (2) singly:

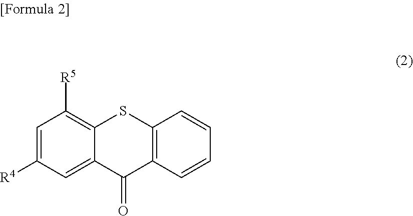

wherein R⁴ and R⁵ each represent —H, —CH₂CH₃, -iPr, or Cl, and R⁴ and R⁵ may be the same or different; or use a compound represented by the general formula (2) together with a photopolymerization initiator high in sensitivity to light rays of 380 nm or more wavelength, this initiator being to be detailed later. In the case of the use of the compound represented by the general formula (2), the resultant adhesive layer is better in adhesion than in the case of a single use of the photopolymerization initiator high in sensitivity to light rays of 380 nm or more wavelength. Out of compounds each represented by the general formula (2), diethylthioxanthone, in which R⁴ and R⁵ are each —CH₂CH₃, is particularly preferred. In the curable resin composition, the composition proportion of the compound represented by the general formula (2) is preferably from 0.1 to 5% by weight, more preferably from 0.5 to 4% by weight, even more preferably from 0.9 to 3% by weight of the whole of the curable resin composition.

A polymerization initiation aid may be optionally added to the composition. Examples of the polymerization initiation aid include triethylamine, diethylamine, N-methyldiethanolamine, ethanolamine, 4-dimethylaminobenzoic acid, methyl 4-dimethylaminobenzoate, ethyl 4-dimethylaminobenzoate, and isoamyl 4-dimethylaminobenzoate. Ethyl 4-dimethylaminobenzoate is particularly preferred. When the polymerization initiation aid is used, the addition amount thereof is usually from 0 to 5%, preferably from 0 to 4%, most preferably from 0 to 3% by weight of the whole of the curable resin composition.

A known photopolymerization initiator may be optionally together used. A transparent protective film having a UV absorbing power does not transmit any light ray of 380 nm or less wavelength. Thus, it is preferred to use, as the photopolymerization initiator, a photopolymerization initiator high in sensitivity to light rays of 380 nm or more wavelength. Specific examples thereof include 2-methyl-1-(4-methylthiophenyl)-2-morpholinopropane-1-one, 2-benzyl-2-dimethylamino-1-(4-morpholinophenyl)-butanone-1, 2-(dimethylamino)-2-[(4-methylphenyl)methyl]-1-[4-(4-morpholinyl)phenyl]-1-butanone, 2,4,6-trimethylbenzoyl-diphenyl-phosphine oxide, bis(2,4,6-trimethylbenzoyl)-phenylphosphine oxide, and bis(η5-2,4-cyclopentadiene-1-yl)-bis(2,6-difluoro-3-(1H-pyrrol-1-yl)-phenyl)titanium.

It is particularly preferred that together with the photopolymerization initiator of the general formula (2), a compound represented by the following general formula (3) is used as another photopolymerization initiator:

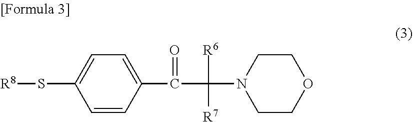

wherein, R⁶, R⁷ and R⁸ each represent —H, —CH₃, —CH₂CH₃, -iPr or Cl, and R⁶, R⁷ and R⁸ may be the same or different. A preferably usable example of the compound represented by the general formula (3) is 2-methyl-1-(4-methylthiophenyl)-2-morpholinopropane-1-one, which is also a commercially available product (trade name: IRGACURE 907, manufacturer: the company BASF). Additionally, the following are preferred because of high sensitivity thereof: 2-benzyl-2-dimethylamino-1-(4-morpholinophenyl)-butanone-1 (trade name: IRGACURE 369, manufacturer: the BASF), 2-(dimethylamino)-2-[(4-methylphenyl)methyl]-1-[4-(4-morpholinyl)phenyl]-1-butanone (trade name: IRGACURE 379, manufacturer: the BASF).

<Radical Polymerizable Compound Having Active Methylene Group, and Radical Polymerization Initiator Having Hydrogen-Withdrawing Effect>

In the case of using, in the active-energy-ray-curable resin composition, a radical polymerizable compound having an active methylene group as a radical polymerizable compound, it is preferred to use a combination of this compound with a radical polymerization initiator having hydrogen-withdrawing effect. This structure makes a remarkable improvement of the resultant adhesive layer, which a polarizing film has, in adhesion even immediately after the polarizing film is taken out, particularly, from a high-humidity environment or water (even when the film is in a non-dry state). Reasons therefor are unclear. However, the improvement would be based on the following causes: While the active-methylene-group-having radical polymerizable compound is polymerized together with other radical polymerizable compounds that will be included in the adhesive layer, the compound is taken into a main chain and/or side chains of a base polymer in the adhesive layer to form the adhesive layer. In this polymerizing step, in the presence of the radical polymerization initiator having hydrogen-withdrawing effect, the base polymer, which will be included in the adhesive layer, is formed and simultaneously hydrogen is withdrawn from the active-methylene-group-having radical polymerizable compound to generate radicals in methylene groups of molecules of this compound. The methylene groups, in which the radicals are generated, react with hydroxyl groups of the polarizer, such as ones of PVA, so that covalent bonds are formed between the adhesive layer and the polarizer. Consequently, the adhesive layer, which the polarizing film has, would be remarkably improved in adhesion even when the polarizing film is, particularly, in a non-dry state.

In the present invention, the radical polymerization initiator having hydrogen-withdrawing effect is, for example, a thioxanthone based radical polymerization initiator, or a benzophenone based radical polymerization initiator. The radical polymerization initiator is preferably a thioxanthone based radical polymerization initiator. The thioxanthone based radical polymerization initiator may be a compound represented by the general formula (2). Specific examples of the compound represented by the general formula (2) include thioxanthone, dimethylthioxanthone, diethylthioxanthone, isopropylthioxanthone, and chlorothioxanthone. Out of compounds each represented by the general formula (2), particularly preferred is diethylthioxanthone, in which R⁴ and R⁵ are each —CH₂H₃.

When the active-energy-ray-curable resin composition contains the active-methylene-group-having radical polymerizable compound and the radical polymerization initiator having hydrogen-withdrawing effect, it is preferred that the composition contains the active-methylene-group-having radical polymerizable compound in an amount of 1 to 50% by weight of the whole of curable components, the amount of which being 100% by weight, and the radical polymerization initiator in an amount of 0.1 to 10% by weight of the curable resin composition.

As described above, in the present invention, radicals are generated in methylene groups of molecules of the active-methylene-group-having radical polymerizable compound in the presence of the radical polymerization initiator having hydrogen-withdrawing effect. This methylene groups react with hydroxyl groups of the polarizer, such as ones of PVA, to form covalent bonds. Thus, in order to generate radicals in the methylene groups of molecules of the active-methylene-group-having radical polymerizable compound to form covalent bonds sufficiently, the resin composition contains the active-methylene-group-having radical polymerizable compound in an amount preferably from 1 to 50%, more preferably from 3 to 30% by weight of the whole of curable components in the composition, the proportion of the whole being 100% by weight. In order to improve the resultant adhesive layer sufficiently in water resistance to improve the layer in a non-dry state in adhesion, the amount of the active-methylene-group-having radical polymerizable compound is preferably 1% or more by weight. In the meantime, if the amount is more than 50% by weight, the adhesive layer may be poorly cured. The amount of the radical polymerization initiator having hydrogen-withdrawing effect is contained in the curable resin composition in an amount preferably from 0.1 to 10%, more preferably from 0.3 to 9% by weight of the whole of this composition. In order to advance the hydrogen-withdrawing reaction sufficiently, it is preferred to use the radical polymerization initiator in an amount of 0.1% or more by weight. In the meantime, if the amount is more than 10% by weight, the initiator may not be completely dissolved in the composition.

<Cationic Photopolymerization Initiator>

The cationic polymerization curable resin composition includes, as a curable component, at least one selected from the above-mentioned epoxy-group-having compound, oxetanyl-group-having compound, and vinyl-ether-group-having compound. These compounds are each a compound curable by cationic polymerization. Thus, a cationic photopolymerization initiator is blended into the composition. This cationic photopolymerization initiator is irradiated with an active energy ray, such as a visible ray, an ultraviolet ray, an X-ray or an electron beam, to generate a cationic species or Lewis acid to initiate a polymerization reaction of epoxy groups or oxetanyl groups. As the cationic photopolymerization initiator, an acid photo-generator and a base photo-generator are usable. Acid photo-generators which will be described later are preferably usable. When the curable resin composition used in the present invention is used in the form of visible ray curability, it is preferred to use a cationic photopolymerization initiator high in sensitivity, particularly, to light rays of 380 nm or more wavelength. Cationic photopolymerization initiators are generally compounds each showing a maximum absorption near 300 nm or in a wavelength band shorter than 300 nm. Thus, by blending, into the resin composition, a photosensitizer showing a maximum absorption in a wavelength band longer than 300 nm, specifically in a light wavelength band longer than 380 nm, the resin composition becomes sensitive to light rays having wavelengths near this band, so that from the cationic photopolymerization initiator, the generation of a cationic species or acid can be promoted. Examples of the photosensitizer include anthracene compounds, pyrene compounds, carbonyl compounds, organic sulfur compounds, persulfides, redox compounds, azo- and diazo-compounds, halogen compounds, and optically reducible colorants. These may be used in the form of a mixture of two or more thereof. In particular, anthracene compounds are preferred since the compounds are excellent in photosensitive effect. Specific examples thereof include products ANTHRACURE UVS-1331 and ANTHRACURE UVS-1221 (manufactured by Kawasaki Kasei Chemical Ltd.). The content of the photosensitizer is preferably from 0.1 to 5%, more preferably from 0.5 to 3% by weight.

<Other Components>

The curable resin composition used in the present invention preferably contains components described below.

<Acrylic Oligomer>

The active-energy-ray-curable resin composition used in the present invention may contain, besides the curable component(s) related to the above-mentioned radical polymerizable compound, an acrylic oligomer obtained by polymerizing a (meth)acrylic monomer. By incorporating the component into the active-energy-ray-curable resin composition, this composition is decreased in curing shrinkage when irradiated with an active energy ray to be cured, so that interfacial stress can be decreased between the adhesive, and adherends such as a polarizer and a transparent protective film. As a result, the adhesion between the adhesive layer and the adherends can be restrained from being lowered. In order to restrain the curing shrinkage of the cured product layer (adhesive layer) sufficiently, the content of the acrylic oligomer in the curable resin composition is preferably 20% or less, more preferably 15% or less by weight of the whole of the composition. If the content of the acrylic oligomer in the curable resin composition is too large, the composition is intensely lowered in reaction rate when irradiated with an active energy ray. Thus, the composition may be poorly cured. In the meantime, the acrylic oligomer is contained in the curable resin composition in a proportion that is preferably 3% or more, more preferably 5% or more by weight of the whole of the curable resin composition.

The active-energy-ray-curable resin composition is preferably low in viscosity when a consideration is made about the workability or evenness of the composition when the composition is painted. Thus, it is also preferred that the acrylic oligomer, which is obtained by polymerizing a (meth)acrylic monomer, is also low in viscosity. About the acrylic oligomer that is low in viscosity and can prevent the resultant adhesive layer from undergoing curing shrinkage, the weight-average molecular weight (Mw) thereof is preferably 15000 or less, more preferably 10000 or less, in particular preferably 5000 or less. In the meantime, in order to restrain the cured product layer (adhesive layer) sufficiently from undergoing curing shrinkage, the weight-average molecular weight (Mw) of the acrylic oligomer is preferably 500 or more, more preferably 1000 or more, in particular preferably 1500 or more. Specific examples of the (meth)acrylic monomer, from which the acrylic oligomer is made, include methyl (meth)acrylate, ethyl (meth)acrylate, n-propyl (meth)acrylate, isopropyl (meth)acrylate, 2-methyl-2-nitropropyl (meth)acrylate, n-butyl (meth)acrylate, isobutyl (meth)acrylate, S-butyl (meth)acrylate, t-butyl (meth)acrylate, n-pentyl (meth)acrylate, t-pentyl (meth)acrylate, 3-pentyl (meth)acrylate, 2,2-dimethylbutyl (meth)acrylate, n-hexyl (meth)acrylate, cetyl (meth)acrylate, n-octyl (meth)acrylate, 2-ethylhexyl (meth)acrylate, 4-methyl-2-propylpentyl (meth)acrylate, N-octadecyl (meth)acrylate, and other (C₁-C₂₀)alkyl esters of (meth)acrylic acid; and cycloalkyl (meth)acrylates (such as cyclohexyl (meth)acrylate, and cyclopentyl (meth)acrylate), aralkyl (meth)acrylates (such as benzyl (meth)acrylate), polycyclic (meth)acrylates (such as 2-isobornyl (meth)acrylate, 2-norbornylmethyl (meth)acrylate, 5-norbornene-2-yl-methyl (meth)acrylate, and 3-methyl-2-norbornylmethyl (meth)acrylate), hydroxy-group-containing (meth)acrylates (such as hydroxyethyl (meth)acrylate, 2-hydroxypropyl (meth)acrylate, and 2,3-dihydroxypropylmethyl-butyl (meth)methacrylate), alkoxy-group- or phenoxy-group-containing (meth)acrylates (such as 2-methoxyethyl (meth)acrylate, 2-ethoxyethyl (meth)acrylate, 2-methoxymethoxyethyl (meth)acrylate, 3-methoxybutyl (meth)acrylate, ethylcarbitol (meth)acrylate, and phenoxyethyl (meth)acrylate), epoxy-group-containing (meth)acrylates (such as glycidyl (meth)acrylate), halogen-containing (meth)acrylates (such as 2,2,2-trifluoroethyl (meth)acrylate, 2,2,2-trifluoroethylethyl (meth)acrylate, tetrafluoropropyl (meth)acrylate, hexafluoropropyl (meth)acrylate, octafluoropentyl (meth)acrylate, and heptadecafluorodecyl (meth)acrylate), and alkylaminoalkyl (meth)acrylates (such as dimethylaminoethyl (meth)acrylate). These (meth)acrylates may be used singly or in combination of two or more thereof. Specific examples of the acrylic oligomer include products “ARUFON” manufactured by Toagosei Co., Ltd., “ACTFLOW” manufactured by Soken Chemical & Engineering Co., Ltd., and “JONCRYL” manufactured by BASF Japan Ltd.

<Optical Acid-Generator>

The active-energy-ray-curable resin composition may contain an optical acid-generator. When the active-energy-ray-curable resin composition contains the optical acid-generator, the adhesive layer can be dramatically made better in water resistance and endurance when the composition does not contain any optical acid-generator.

The optical acid-generator can be represented by the following general formula (4).

General formula (4)

L⁺X⁻ [Formula 4]

wherein L⁺ represents any onium cation; and X⁻ represents a counter anion selected from the group consisting of PF6₆⁻, SbF₆⁻, AsF₆⁻, SbCl₆⁻, BiCl₅⁻, SnCl₆⁻, ClO₄⁻, a dithiocarbamate anion, and SCN⁻.

Next, a description will be made about the counter anion in the general formula (4).

The counter anion X⁻ in the general formula (4) is not particularly limited in principle, and is preferably a non-nucleophilic anion. When the counter anion X⁻ is the non-nucleophilic anion, a nucleophilic reaction is not easily caused with a cation existing therewith in the molecule or various materials used together. As a result, the optical acid-generator itself, which is represented by the general formula (4), and a composition using this agent can be improved in stability over time. The non-nucleophilic anion referred to herein denotes an anion low in power for causing nucleophilic reaction. Examples of the anion include PF6₆⁻, SbF₆⁻, AsF₆⁻, SbCl₆⁻, BiCl₅⁻, SnCl₆⁻, ClO₄⁻, a dithiocarbamate anion, and SCN⁻.

Preferred and specific examples of the optical acid-generator in the present invention include products “CYRACURE UVI-6992”, and “CYRACURE UVI-6974” (each manufactured by Dow Chemical Japan Ltd.), “ADEKA OPTOMER SP150”, “ADEKA OPTOMER SP152”, “ADEKA OPTOMER SP170”, and “ADEKA OPTOMER SP172” (each manufactured by ADEKA Corp.), “IRGACURE 250” (manufactured by Ciba Specialty Chemicals Corp.), “CI-5102”, and “CI-2855” (each manufactured by Nippon Soda Co., Ltd.), “SAN-AID SI-60L”, “SAN-AID SI-80L”, “SAN-AID SI-100L”, “SAN-AID SI-110L”, and “SAN-AID SI-180L” (each manufactured by Sanshin Chemical Industry Co., Ltd.), “CPI-100P”, and “CPI-100A” (each manufactured by San-Apro Ltd.), “WPI-069”, “WPI-113”, “WPI-116”, “WPI-041”, “WPI-044”, “WPI-054”, “WPI-055”, “WPAG-281”, “WPAG-567”, and “WPAG-596” (each manufactured by Wako Pure Chemical Industries, Ltd.).

The content of the optical acid-generator is 10% or less, preferably from 0.01 to 10%, more preferably from 0.05 to 5%, in particular preferably from 0.1 to 3% by weight of the whole of the curable resin composition.

<Optical Base-Generator>

The optical base-generator is a compound which produces one or more base substances that can function as a catalyst, for polymerization reaction of a radical polymerizable compound or epoxy resin, by the matter that a molecular structure of this compound is changed by light-irradiation with, for example, an ultraviolet ray or visible ray, or the matter that the molecule is cleaved thereby. Examples of the base substances include secondary amines, and tertiary amines. Examples of the optical base-generator include the above-mentioned α-aminoacetophenone compounds, the above-mentioned oxime ester compounds, and compounds each having a substituent such as an acyloxyimino group, N-formylated aromatic amino group, N-acylated aromatic amino group, nitrobenzyl carbamate group or alkoxybenzyl carbamate group. Out of these examples, oxime ester compounds are preferred.

Examples of the compounds each having an acyloxyimino group include O,O′-diacetophenone oxime succinate, O,O′-dinaphthophenone oxime succinate, and benzophenone-oxime-acrylate/styrene copolymer.

Examples of the compounds each having an N-formylated aromatic amino group and the compounds each having an N-acylated aromatic amino group include di-N-(p-formylamino)diphenylmethane, di-N(p-acetylamino)diphenylmethane, di-N-(p-benzamide)diphenylmethane, 4-formylaminotoluylene, 4-acetylaminotoluylene, 2,4-diformylaminotoluylene, 1-formylaminonaphthalene, 1-acetylaminonaphthalene, 1,5-diformylaminonaphthalene, 1-formylaminoanthracene, 1,4-diformylaminoanthracene, 1-acetylaminoanthracene, 1,4-diformylaminoanthraquinone, 1,5-diformylaminoanthraquinone, 3,3′-dimethyl-4,4′-diformylaminobiphenyl, and 4,4′-diformylaminobenzophenone.

Examples of the compounds each having a nitrobenzyl carbamate group and the compounds each having an alkoxybenzyl carbamate group include bis{{(2-nitrobenzyl)oxy}carbonyl}diaminodiphenylmethane, 2,4-di{{(2-nitrobenzyl)oxy}toluylene, bis{{(2-nitrobenzyloxy)carbonyl}hexane-1, 6-diamine, and m-xylidine{{(2-nitro-4-chlorobenzyl)oxy}amide}.

The optical base-generator is preferably at least one of oxime ester compounds and α-aminoacetophenone compounds, and is more preferably an oxime ester compound. The α-aminoacetophenone compounds are in particular preferably ones having two or more nitrogen atoms.

Other usable examples of the optical base-generator are products WPBG-018 (trade name), 9-anthrylmethyl N,N′-diethylcarbamate); WPBG-027 (trade name), (E)-1-[3-(2-hydroxyphenyl)-2-propenoyl]piperidine); WPBG-082 (trade name), guanidinium 2-(3-benzoylphenyl) propionate); WPBG-140 (trade name), 1-(anthraquinone-2-yl)ethyl imidazolecarboxylate); and other optical base-generators.

<Compound Containing any One of Alkoxy Group and Epoxy Group>

About the active-energy-ray-curable resin composition, the optical acid-generator may be used together with a compound containing any one of an alkoxy group and an epoxy group in the active-energy-ray-curable resin composition.

(Compound and Polymer Having Epoxy Group)

In the case of using a compound having in the molecule thereof one or more epoxy groups, or a polymer having in the molecule thereof two or more epoxy groups (epoxy resin), a compound having in the molecule thereof two or more functional groups reactive with any epoxy group may be used together. Examples of the functional group(s) reactive with any epoxy group include a carboxyl group, a phenolic hydroxyl group, a mercapto group, and a primary or secondary amino group. The compound in particular preferably has in a single molecule thereof two or more of these functional groups, considering the three-dimensional curability of the resin composition.

The polymer having in the molecule thereof one or more epoxy groups is, for example, an epoxy resin. Examples thereof include bisphenol A type epoxy resin derived from bisphenol A and epichlorohydrin, bisphenol F type epoxy resin derived from bisphenol F and epichlorohydrin, bisphenol S type epoxy resin, phenol novolak type epoxy resin, cresol novolak type epoxy resin, bisphenol A novolak type epoxy resin, bisphenol F novolak type epoxy resin, alicyclic epoxy resin, diphenyl ether type epoxy resin, hydroquinone type epoxy resin, naphthalene type epoxy resin, biphenyl type epoxy resin, fluorene type epoxy resin, polyfunctional epoxy resins such as trifunctional epoxy resin and tetrafunctional epoxy resin, glycidylester type epoxy resin, glycidylamine type epoxy resin, hydantoin type epoxy resin, isocyanurate type epoxy resin, and aliphatic linear epoxy resin. These epoxy resins may be halogenated, and may be hydrogenated. Examples of a commercially available product of the epoxy resin include JER COATs 828, 1001, 801N, 806, 807, 152, 604, 630 and 871, YX8000, YX8034, and YX4000 manufactured by Japan Epoxy Resins Co., Ltd.; EPICLON 830, EXA 835LV, HP 4032D, HP 820 manufactured by DIC CORPORATION; EP 4100 series, EP 4000 series, and EPU series manufactured by ADEKA Corp.; CELLOXIDE series (2021, 2021P, 2083, 2085, 3000, and others), EPOLEAD series, and EHPE series manufactured by Daicel Corp.; YD series, YDF series, YDCN series, YDB series, and phenoxy resins (YP series and others: polyhydroxypolyethers each synthesized from a bisphenol and epichlorohydrin and each having, at both ends thereof, epoxy groups, respectively) manufactured by Nippon Steel Chemistry Co., Ltd.; DENACOL series manufactured by Nagase ChemteX Corp.; and EPOLIGHT series and others, manufactured by Kyoeisha Chemical Co., Ltd. However, the commercially available epoxy resin product is not limited to these examples. These epoxy resins may be used in combination of two or more thereof.

(Compound and Polymer Each Having Alkoxy Group)

The compound having in the molecule thereof an alkoxy group is not particularly limited as far as the compound is a compound having in the molecule thereof one or more alkoxy groups. The compound may be any known compound. Typical examples of the compound include a melamine compound, an amino resin, and a silane coupling agent.

The blend amount of the compound containing any one of an alkoxy group and an epoxy group is usually 30% or less by weight of the whole of the curable resin composition. If the content of the compound in the composition is too large, the resultant adhesive layer is lowered in adhesion, so that the impact resistance thereof may be deteriorated in a dropping test. The content by proportion of the compound in the composition is more preferably 20% or less by weight. In the meantime, the composition contains the compound in a proportion that is preferably 2% or more, more preferably 5% or more by weight from the viewpoint of the water resistance of the composition.

<Silane Coupling Agent>

When the curable resin composition used in the present invention is active energy ray curable, the silane coupling agent is preferably an active-energy-ray-curable compound. However, even when the silane coupling agent is not active energy ray curable, this agent can give substantially the same water resistance to the composition.

Specific examples of the silane coupling agent include, as active-energy-ray-curable compounds, vinyltrichlorosilane, vinyltrimethoxysilane, vinyltriethoxysilane, 2-(3,4 epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, and 3-acryloxypropyltrimethoxy silane.

The silane coupling agent is preferably 3-methacryloxypropyltrimethoxysilane, or 3-acryloxypropyltrimethoxysilane.

A specific example of the silane coupling agent that is not active energy ray curable is a silane coupling agent (D1) having an amino group. Specific examples of the silane coupling agent (D1), which has an amino group, include γ-aminopropyltrimethoxysilane, γ-aminopropyltriethoxysilane, γ-aminopropyltriisopropoxysilane, γ-aminopropylmethyldimethoxysilane, γ-aminopropylmethyldiethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, γ-(2-aminoethyl)aminopropyltriisopropoxysilane, γ-(2-(2-aminoethyl)aminoethyl) aminopropyltrimethoxysilane, γ-(6-aminohexyl) aminopropyltrimethoxysilane, 3-(N-ethylamino)-2-methyl propyltrimethoxysilane, γ-ureidopropyltrimethoxysilane, γ-ureidopropyltriethoxysilane, N-phenyl-γ-aminopropyltrimethoxysilane, N-benzyl-γ-aminopropyltrimethoxysilane, N-vinylbenzyl-γ-aminopropyltriethoxysilane, N-cyclohexylaminomethyltriethoxysilane, N-cyclohexylaminomethyldiethoxymethylsilane, N-phenylaminomethyltrimethoxysilanesilane, (2-aminoethyl)aminomethyltrimethoxysilane, N,N′-bis[3-(trimethoxysilyl)propyl]ethylenediamine, and other amino-group-containing silanes; and N-(1,3-dimethylbutylidene)-3-(triethoxysilyl)-1-propanamine, and other ketimines type silanes.

Such silane coupling agents (D1) each having an amino group may be used singly, or in combination of two or more thereof. Out of these compounds, the following are preferred in order for the curable resin composition to ensure good adhesion: γ-aminopropyltrimethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, and N-(1,3-dimethylbutylidene)-3-(triethoxysilyl)-1-propanamine.

The blend amount of the silane coupling agent is preferably from 0.01 to 20%, preferably from 0.05 to 15%, even more preferably from 0.1 to 10% by weight of the whole of the curable resin composition. If the blend amount is more than 20% by weight, the curable resin composition is deteriorated in storage stability. If the blend amount is less than 0.1% by weight, the composition does not sufficiently exhibit an adhesion water-resistance effect.

Specific examples of the silane coupling agent that is not active energy ray curable, these examples being other than the above-mentioned examples, include 3-ureidopropyltriethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanatopropyltriethoxysilane, and imidazolesilane.

<Compound Having Vinyl Ether Group>

The curable resin composition used in the present invention may contain a compound having a vinyl ether group. This case is favorable since a polarizer and the resultant adhesive layer are improved in adhesion water-resistance therebetween. Reasons why this advantageous effect is gained are unclear; however, it is presumed that one of the reasons is as follows: the vinyl ether group, which the compound has, interacts with the polarizer to heighten the adhering strength between the polarizer and the adhesive layer. In order to heighten the polarizer and the adhesive layer further in adhesion water-resistance therebetween, the compound is preferably a radical polymerizable compound having a vinyl ether group. The content of the compound is preferably from 0.1 to 19% by weight of the whole of the curable resin composition.

<Keto-Enol Tautomerism Generable Compound>

A compound in which keto-enol tautomerism is generable may be incorporated into the curable resin composition used in the present invention. It is preferred to use, for example, an embodiment in which this keto-enol tautomerism generable compound is contained in the curable resin composition that contains a crosslinking agent or that is usable in the state of blending a crosslinking agent into the composition. This embodiment allows to restrain the curable resin composition, after the blending of an organometallic compound into the composition, from being excessively raised in viscosity or gelatinized, and from undergoing the production of a micro-gelatinized product, so as to realize an effect of prolonging the pot life of this composition.

The keto-enol tautomerism generable compound may be a β-dicarbonyl compound that may be of various types. Specific examples thereof include acetylacetone, 2,4-hexanedione, 3,5-heptanedione, 2-methylhexane-3,5-dione, 6-methylheptane-2,4-dione, 2,6-dimethylheptane-3,5-dione, and other β-diketones; methyl acetoacetate, ethyl acetoacetate, isopropyl acetoacetate, tert-butyl acetoacetate, and other acetoacetates; ethyl propionylacetate, ethyl propionylacetate, isopropyl propionylacetate, tert-butyl propionylacetate, and other propionylacetates; ethyl isobutyrylacetate, ethyl isobutyrylacetate, isopropyl isobutyrylacetate, tert-butyl isobutyrylacetate, and other isobutyrylacetates; and methyl malonate, ethyl malonate, and other malonates. Out of these examples, acetylacetone and acetoacetates are preferred compounds. These keto-enol tautomerism generable compounds may be used singly or in combination of two or more thereof.

The use amount of the keto-enol tautomerism generable compound(s) may be, for example, from 0.05 to 10 parts, preferably from 0.2 to 3 parts (for example, from 0.3 to 2 parts) by weight per part by weight of the above-mentioned organometallic compound. If the use amount of the compound is less than 0.05 part by weight per part by weight of the organometallic compound, the use effects thereof may not be sufficiently exhibited with ease. In the meantime, if the use amount of the compound is more than 10 parts by weight per part by weight of the organometallic compound, the compound interacts excessively with the organometallic compound so that a target water resistance may not be easily expressed.

<Polyrotaxane>

A polyrotaxane may be incorporated into the curable resin composition of the present invention. The polyrotaxane has a cyclic molecule, a linear molecule which penetrates an opening moiety of the cyclic molecule, and sealing groups which are arranged, respectively, at both ends of the linear molecule to cause the cyclic molecule not to be eliminated from the linear molecule. The cyclic molecule preferably has an active-energy-ray-curable functional group.

The linear molecule is not particularly limited as far as the molecule is a molecule which has an opening moiety into which the linear molecule is included in a skewering form, which can be shifted onto the linear molecule, and which has an active-energy-ray-polymerizable group. In the document DESCRIPTION, the word “cyclic” in the wording “cyclic molecule” means that the molecule is substantially “cyclic”. In other words, the cyclic molecule may not be completely in a closed ring form as far as the molecule can be shifted onto the linear molecule.

Specific and preferred examples of the cyclic molecule include cyclic polyethers, cyclic polyesters, cyclic polyetheramines, and other cyclic polymers; and α-cyclodextrin, β-cyclodextrin, γ-cyclodextrin, and other cyclodextrins. Out of such compounds, preferred are α-cyclodextrin, β-cyclodextrin, γ-cyclodextrin, and other cyclodextrins since these compounds are relatively easily available, and the species of their sealing groups can be selected from many species. Two or more cyclic molecules may be present in a mixture form in the polyrotaxane or the adhesive.

In the polyrotaxane used in the present invention, (each of) the cyclic molecule(s) has an active-energy-ray-polymerizable group. This matter may provide that the polyrotaxane reacts with the active-energy-ray-curable component to give an adhesive in which crosslinkage points are movable after the adhesive is cured. The active-energy-ray-polymerizable group, which the cyclic molecule has, may be any group as far as the group is polymerizable with the above-mentioned active-energy-ray-curable compound. Examples thereof include (meth)acryloyl groups, and (meth)acryloyloxy groups.

When a cyclodextrin is used as the cyclic molecule, the active-energy-ray-polymerizable group is introduced into a hydroxyl group of the cyclodextrin preferably to interpose any appropriate linker therebetween. The number of active-energy-ray-polymerizable groups which any one molecule of the polyrotaxane has is preferably from 2 to 1280, more preferably from 50 to 1000, even more preferably from 90 to 900.

A hydrophobic modifying group is preferably introduced into the cyclic molecule. The introduction of the hydrophobic modifying group may improve the polyrotaxane in compatibility with the active-energy-ray-curable component. Moreover, when the resultant adhesive layer is used for a polarizing film, the introduction may prevent water from invading an interface between the adhesive layer and a polarizer of this polarizing film to improve the polarizing film further in water resistance. Examples of the hydrophobic modifying group include polyester chains, polyamide chains, alkyl chains, oxyalkylene chains, and ether chains. Specific examples thereof include groups described in WO 2009/145073, paragraphs [0027] to [0042].

A polarizing film using, as an adhesive, the resin composition which contains the polyrotaxane is excellent in water resistance. Reasons why the polarizing film is improved in water resistance are unclear; however, the reasons are presumed as follows: The mobility of the cyclic molecule(s) of the polyrotaxane can cause the crosslinkage points to be movable (the so-called pulley effect). This effect gives flexibility to the cured adhesive so that the polarizer is increased in close adhesion to surface-irregularities. As a result, water would be prevented from invading the interface between the polarizer and the adhesive layer. Furthermore, hydrophobicity is given to the adhesive by the matter that the polyrotaxane has the hydrophobic modifying group. It is considered that this matter would also contribute to the prevention of the invasion of water into the interface between the polarizer and the adhesive layer.

The content of the polyrotaxane is preferably from 2 to 50% by weight of the resin composition.

The curable resin composition may contain a compound represented by the following general formula (5):

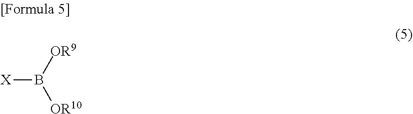

wherein X is a functional group containing at least one reactive group selected from the group consisting of vinyl, (meth)acryl, styryl, (meth)acrylamide, vinyl ether, epoxy, oxetane, and mercapto groups, and R⁹ and R¹⁰ each independently represent a hydrogen atom, or an aliphatic hydrocarbon, aryl or heterocyclic group that may have a substituent. The compound represented by the general formula (5) is easily combined with hydroxyl groups which a polyvinyl alcohol based polarizer has to form ester bonds. The compound represented by the general formula (5) further has X containing a reactive group, and reacts with the other curable component(s) contained in the curable resin composition through the reactive group which X contains. In other words, the boric acid group and/or the borate group which the curable resin layer has is/are strongly adhered to the hydroxyl groups which the polarizer has. Even when water is present on an interface between the polarizer and the curable resin layer, this strong bonding makes a dramatic improvement of the polarizer and the curable resin layer in adhesion water-resistance therebetween since the polarizer and the layer interact strongly with each other through not only hydrogen bonding and/or ion bonding but also covalent bonding. From the viewpoint of an improvement of the polarizer and the cured product layer in adhesion therebetween and water resistance, in particular, an improvement of the polarizer and a transparent protective film in adhesion therebetween and water resistance when the polarizer and this film adhere to each other through the adhesive layer, the content of the compound represented by the general formula (5) in the curable resin composition is preferably from 0.001 to 50%, more preferably from 0.1 to 30%, most preferably from 1 to 10% by weight.

<Organometallic Compound>

When the curable resin composition of the present invention simultaneously contains at least one organometallic compound selected from the group consisting of metal alkoxides and metal chelates, and a polymerizable compound having a polymerizable functional group and a carboxyl group, the polarizer and the adhesive layer are favorably improved in adhesion water-resistance therebetween. Thus, this case is preferred. The organometallic compound is turned to an active metal species by aid of water. As a result, the organometallic compound interacts strongly with both of the polarizer, and the active-energy-ray-curable component, which constitutes the adhesive layer. In this way, even when water is present on the interface between the polarizer and the adhesive layer, a dramatic improvement of the polarizer and the adhesive layer is made in adhesion water-resistance therebetween since the polarizer and this layer interact strongly with each other through the organometallic compound. Although the organometallic compound contributes greatly to the improvement of the adhesive layer in adhesion and water resistance, the composition containing this compound becomes instable in liquid stability. This matter tends to cause the resin composition to be shortened in pot life to give a deteriorated producibility. It is presumed that one cause for this matter is based on the following: the organometallic compound is high in reactivity so that the compound contacts water contained in a slight quantity in the composition to undergo hydrolysis reaction and self-condensation reaction; consequently, the compound is self-aggregated to cause cloudiness of the composition liquid (the generation of aggregates, phase-separation, and precipitation). However, when the composition contains the polymerizable compound containing a polymerizable functional group and a carboxyl group together with the organometallic compound, the organometallic compound is restrained from undergoing hydrolysis reaction and self-condensation reaction, so that the organometallic compound in the composition can be dramatically improved in liquid stability. The proportion of the organometallic compound is preferably from 0.05 to 15%, more preferably from 0.1 to 10% by weight of the whole of the composition. If the blend proportion is more than 15% by weight, it is feared that the composition is deteriorated in storage stability, and the proportion of the component for adhering to the polarizer or protective film becomes relatively small so that the composition is lowered in adhesion. If the proportion is less than 0.05% by weight, the effect of the adhesion water-resistance is not sufficiently exhibited. When the total amount of the organometallic compound in the curable adhesive composition is represented by α (mol), the content of the polymerizable compound having a polymerizable functional group and a carboxyl group is preferably 0.25α (mol) or more, more preferably 0.35α (mol) or more, in particular preferably 0.5α (mol) or more. If the content of the polymerizable compound having a polymerizable functional group and a carboxyl group is less than 0.25α (mol), the organometallic compound becomes insufficient in stability so that the hydrolysis reaction and the self-condensation reaction may advance to shorten the pot life. The upper limit of the content of the polymerizable compound that is relative to the total amount α (mol) of the organometallic compound is not particularly limited, and may be, for example, about 4α (mol).

<Dopants Other than Above-Mentioned Components>

Various dopants may be blended, as other optional components, into the curable resin composition used in the present invention as far as the object and advantageous effects of the invention are not damaged. Examples of the dopants include epoxy resin, polyamide, polyamideimide, polyurethane, polybutadiene, polychloroprene, polyether, polyester, styrene-butadiene block copolymer, petroleum resin, xylene resin, ketone resin, cellulose resin, fluorine-contained oligomer, silicone based oligomer, polysulfide based oligomer, and other polymers or oligomers; phenothiazine, 2,6-di-t-butyl-4-methylphenol, and other polymerization inhibitors; polymerization initiation aids; leveling agents; wettability improvers; surfactants; plasticizers; ultraviolet absorbers; inorganic fillers; pigments; and dyes.

The amount of the dopants is usually from 0 to 10%, preferably from 0 to 5%, most preferably from 0 to 3% by weight of the whole of the curable resin composition.

<Curable Resin Composition for Optical Films>

About the curable resin composition, for optical films, according to the present invention, at the time of curing this composition the resultant cured product preferably has a bulk water absorption coefficient of 10% or less by weight when this cured product is immersed in pure water of 23° C. temperature for 24 hours. The bulk water absorption coefficient is represented by the following expression:

{(M2−M1)/M1}×100(%) Expression:

wherein M1: the weight of the cured product before the immersion, and M2: the weight of the cured product after the immersion.

In the case of setting the bulk water absorption coefficient to 10% or less by weight, the shift of water to the polarizer is restrained when the polarizing film is put in a severe environment of a high temperature and a high humidity. Thus, the polarizer can be restrained from being raised in transmittance and being lowered in polarization degree. In order to make the adhesive layer of the polarizing film better in optical endurance in a severe environment of a high temperature, the bulk water absorption coefficient is preferably 5% or less, more preferably 3% or less, most preferably 1% or less by weight. When the polarizer is bonded to a transparent protective film, the polarizer keeps a predetermined quantity of water. Thus, when the curable adhesive contacts the water in the polarizer, an external appearance, such as repellence or air foam, may be generated. In order to restrain the poor external appearance, it is preferred that the curable adhesive can absorb a predetermined quantity of water. More specifically, the bulk water absorption coefficient is preferably 0.01% or more, more preferably 0.05% or more by weight.

The viscosity of the curable resin composition used in the present invention is preferably from 3 to 100 mPa·s, more preferably from 5 to 50 mPa·s, most preferably from 10 to 30 mPa·s. If the viscosity of the curable resin composition is high, the layer yielded after the application of the composition is unfavorably poor in surface smoothness to become poor in external appearance. The curable resin composition used in the present invention can be applied in the state of heating or cooling this composition to adjust the viscosity thereof in a preferred range.

It is preferred that the curable resin composition of the present invention has a high octanol/water distribution coefficient (hereinafter referred to as a log Pow value). The log Pow value of a substance is an index representing the lipophilicity of the substance, and is a logarithmic value of the octanol/water distribution coefficient thereof. The matter that a substance is higher in log Pow value means that the substance is more lipophilic, that is, that the substance is lower in water absorption coefficient. The log Pow value is measurable (by a flask shaking method described in JIS-Z-7260); however, the value is also calculable by calculation on the basis of the structure of each of the compounds which are constituent components (the curable component(s) and others) of the curable adhesive for polarizing films. The document DESCRIPTION makes use of log Pow values each calculated through a product ChemDraw Ultra manufactured by Cambridge Soft Corp.

On the basis of the above-mentioned calculated value, the log Pow value of the curable adhesive for polarizing films in the present invention can be calculated by the following expression:

Log Pow value of the curable adhesive=Σ(log Powi×Wi)

wherein log Powi: the log Pow value of each component of the curable adhesive; and
Wi: (the mole number of the component “i”)/(the total mole number of the individual components in the curable adhesive).

In this calculation, out of individual components of the curable adhesive, any component that does not form the skeleton of the cured product (adhesive layer), this component being, for example, any polymerization initiator or optical acid-generator, is excluded from the the components for the calculation. The log Pow value of the curable adhesive of the present invention for polarizing films is preferably 1 or more, more preferably 1.5 or more, most preferably 2 or more. In this manner, the adhesive can be heightened in adhesion water-resistance and humidification endurance. In the meantime, the log Pow value of the curable adhesive of the present invention for polarizing films is usually about 8 or less, preferably 5 or less, more preferably 4 or less. If this log Pow value is too high, an external appearance poorness as described above, such as repellence or air foam, is unfavorably generated.

Furthermore, it is preferred that the curable resin composition of the present invention does not substantially contain any volatile solvent. When the composition does not substantially contain any volatile component, no heating treatment is required, so that optical films are produced with an excellent producibility. Additionally, their polarizer can be restrained from being lowered in optical properties by heat. The wording “does not substantially contain any” component means, for example, the following: when the total amount of the curable resin composition is regarded as 100% by weight, the composition contains the component in a proportion less than 5% by weight, in particular, in a proportion less than 2% by weight.

About the curable resin composition, a cured resin layer, in particular, an adhesive layer that is made of/from this composition preferably has a Tg selected to be 60° C. or higher. The Tg is more preferably 70° C. or higher, even more preferably 75° C. or higher, even more preferably 100° C. or higher, even more preferably 120° C. or higher. If the Tg of the adhesive layer is too high, the polarizing film is lowered in bendability. Thus, the Tg of the adhesive layer is more preferably 300° C. or lower, even more preferably 240° C. or lower, even more preferably 180° C. or lower. The Tg <glass transition temperature> is measured using a dynamic viscoelasticity measuring instrument RSA III manufactured by a company TA Instruments under the following measuring conditions:

Sample size: 10 mm in width and 30 mm in length,

Clamp distance: 20 mm,

Measuring mode: tension, Frequency: 1 Hz, and Temperature-raising rate: 5° C./minute. The dynamic viscoelasticity of a sample is measured, and the temperature of a peak top of the tan δ thereof is adopted as the Tg of the sample.

About the curable resin composition, the cured resin layer, in particular, the adhesive layer, which is made of/from this composition, preferably has a storage modulus of 1.0×10′ Pa or more at 25° C. The storage modulus is more preferably 1.0×10⁸ Pa or more. The storage modulus of a pressure-sensitive-adhesive layer is from 1.0×10³ to 1.0×10⁶ Pa, and is different from that of the adhesive layer. When the polarizing film is subjected to heat cycles (for example, from −40 to 80° C.), the storage modulus of the adhesive layer affects cracking in the polarizer. When the storage modulus is low, an inconvenience of the polarizer-cracking is easily generated. The range of temperatures at which the cured resin layer has a high storage modulus is preferably 80° C. or lower, most preferably 90° C. or lower. At the same time of measuring the Tg <glass transition temperature>, the storage modulus is measured using the dynamic viscoelasticity measuring instrument RSA III manufactured by the company TA Instruments under the same conditions. The dynamic viscoelasticity of a sample was measured, and the resultant storage modulus (E′) value thereof was adopted.

The curable resin composition of the present invention contains the curable component. Thus, when the curable resin composition is cured, the composition usually undergoes curing shrinkage. The coefficient of curing shrinkage is an index for representing the percentage of curing shrinkage generated when an adhesive layer is formed from the resin composition. When the curing shrinkage coefficient of the adhesive layer becomes larger, a more preferred effect is gained for restraining the following: interfacial strain is generated when the curable resin composition is cured to form the adhesive layer, so that adhesion failure is generated. From this viewpoint, the curing shrinkage coefficient related to a cured product yielded by curing the resin composition, which produces the advantageous effects of the present invention, is preferably 10% or less. As the curing shrinkage coefficient is smaller, a more preferred result is gained. The curing shrinkage coefficient is preferably 8% or less, more preferably 5% or less. The curing shrinkage coefficient is measured by a method described in JP-A-2013-104869. Specifically, the coefficient is measured by a method described in examples therein, using a curing shrinkage sensor manufactured by Sentec Co., Ltd.

In the curable resin composition used in the present invention, it is preferred from the viewpoint of safety to use, as the curable component, one or more materials low in skin irritation. The skin irritation can be judged, using an index of P.I.I. The P.I.I is widely used as an index showing the degree of skin disorder, and is measured by a Draize method. The measured value thereof is represented in a range from 0 to 8. As this value is smaller, the irritation is judged to be lower. However, the measured value includes a large accidental; thus, it is advisable to understand this index as a reference value. The P.I.I is preferably 4 or less, more preferably 3 or less, most preferably 2 or less.

<Optical Film>

The curable resin composition according to the present invention is favorably usable for any optical film, in particular, for any polarizing film that has at least a polyvinyl alcohol based polarizer. The following will describe a polarizing film as an example of the optical film.

<Polarizing Film>

In a polarizing film according to the present invention, the following cured product layer is laminated on at least one surface of a polyvinyl alcohol based polarizer: a cured product layer of the curable resin composition for optical films, which includes an active-energy-ray-curable component (A) and a chlorinated polyolefin (B). A transparent protective film may be further laminated onto this polarizing film. The polarizing film may be, for example, a polarizing film in which a transparent protective film is laminated onto at least one surface of a polyvinyl alcohol based polarizer through a cured product layer of the curable resin composition for optical films; or a polarizing film in which the same cured product layer is laminated onto one of the surfaces of a polyvinyl alcohol based polarizer, and a transparent protective film is laminated onto the other surface.

The polarizing film according to the present invention may further have a pressure-sensitive-adhesive layer. The pressure-sensitive-adhesive layer may be laminated onto any site of the polarizing film. Thus, for example, it is allowable to laminate the same cured product layer onto a polyvinyl alcohol based polarizer, and form the pressure-sensitive-adhesive layer onto this laminate; or laminate the same cured product layer to one of the surfaces of a polyvinyl alcohol based polarizer, and laminate a pressure-sensitive-adhesive layer onto the other surface. Alternatively, the pressure-sensitive-adhesive layer may be laminated onto the protective film side of a polarizing film composed of the following: a polarizer/the same cured product layer/a protective film. As described hereinbefore, a pressure-sensitive-adhesive layer may be laminated onto any site of the polarizing film.

About a polarizing film yielded by laminating a polyvinyl alcohol based polarizer, a cured product layer of the composition of the present invention, a transparent protective film, and a pressure-sensitive-adhesive layer onto each other, the thickness thereof is preferably 150 μm or less, more preferably 100 μm or less. If the thickness of the polarizing film is too large, this polarizing film becomes large in dimension change at a high temperature and a high humidity, so that an inconvenience of display-unevenness is unfavorably generated.

The thickness of the cured product layer, in particular, the adhesive layer, which is made from the curable resin composition, is preferably from 0.01 to 3.0 μm. If the thickness of the cured product layer is too small, the cured layer is unfavorably short in cohesive strength to be lowered in peeling force. If the thickness of the cured product layer is too large, a peel is easily caused in the polarizing film when stress is applied to a cross section of this film. Thus, a peel failure is generated therein by impact. The thickness of the cured product layer is more preferably from 0.1 to 2.5 μm, most preferably from 0.5 to 1.5 μm.

The polarizer is not particularly limited, and may be of various types. The polarizer is, for example, a polarizer yielded by causing a dichronic material such as iodine or dichroic dye to be adsorbed into a hydrophilic polymeric film, such as a polyvinyl alcohol film, a partially-formal-converted polyvinyl alcohol film or an ethylene/vinyl acetate copolymer partially-saponified film, and then stretching the resultant uniaxially; or a polyene aligned film made of, for example, a polyvinyl alcohol dehydrated product or a polyvinyl chloride de-hydrochloride-treated product. Out of such polarizers, preferred is a polarizer composed of a polyvinyl alcohol film and a dichronic substance such as iodine. The thickness of such a polarizer is preferably from 2 to 30 μm, more preferably for 4 to 20 μm, most preferably from 5 to 15 μm. If the thickness of the polarizer is small, the polarizer is unfavorably lowered in optical endurance. If the thickness of the polarizer is large, the polarizer becomes large in dimension change at a high temperature and high humidity, so that inconveniences such as display unevenness are unfavorably generated.

The polarizer in which a polyvinyl alcohol based film that has been dyed with iodine has uniaxially stretched can be produced, for example, by immersing a polyvinyl alcohol into an aqueous solution of iodine to be dyed, and then stretching the resultant film into a length 3 to 7 times the original length of this film. As required, the stretched film may be immersed into an aqueous solution of, for example, boric acid or potassium iodide. Furthermore, as required, before the dyeing, the polyvinyl alcohol based film may be immersed into water to be cleaned with water. The cleaning of the polyvinyl alcohol based film with water allows to clean stains and a blocking-preventing agent on surfaces of the polyvinyl alcohol based film, and further produce an advantageous effect of swelling the polyvinyl alcohol based film to prevent unevenness of the dyeing, and any other unevenness. The stretching may be performed after the dyeing with iodine or while the dyeing is performed. Alternatively, after the stretching, the dyeing with iodine may be performed. The stretching may be performed in an aqueous solution of, for example, boric acid or potassium iodide, or in a water bath.

When a thin polarizer having a thickness of 10 μm or less is used as the polarizer, the active-energy-ray-curable resin composition used in the present invention can remarkably produce the advantageous effect thereof (that the resultant layer satisfies optical endurance in a severe environment at a high temperature and high humidity). The polarizer, the thickness of which is 10 μm or less, is more largely affected by water than any polarizer having a thickness more than 10 μm. Consequently, the former is insufficient in optical endurance in an environment at a high temperature and high humidity to be easily raised in transmittance or lowered in polarization degree. In other words, in the case of laminating the polarizer, the thickness of which is 10 μm or less through an adhesive layer having a bulk water absorption of 10% or less by weight in the invention, the shift of water into the polarizer is restrained in a severely high temperature and high humidity environment. Consequently, the polarizing film can be remarkably restrained from undergoing deteriorations in optical endurances, such as a rise in transmittance and a lowering in polarization degree. The thickness of the polarizer is preferably from 1 to 7 μm from the viewpoint of making the polarizing film thinner. Such a thin polarizer is small in thickness unevenness, excellent in perceptibility, and small in dimension change. Furthermore, favorably, this thin polarizer also makes the polarizing film small in thickness.

Typical examples of the thin polarizer include thin polarizing membranes described in JP-A-S51-069644, JP-A-2000-338329, a pamphlet of WO 2010/100917, and specifications of PCT/JP2010/001460 and Japanese Patent Applications No. 2010-269002 and No. 2010-263692. These thin polarizing membranes can each be yielded by a producing method including the step of stretching a polyvinyl alcohol based resin (hereinafter referred to also as a PVA based resin) and a resin substrate for stretching in a laminate state, and the step of dyeing the laminate. This producing method allows to stretch the laminate, even when the PVA based resin layer is thin, without causing inconveniences, such as breaking, by the stretching, on the basis of the supporting of the PVA based resin layer on the resin substrate for stretching.

The thin polarizing membranes are preferably polarizing membranes each yielded by the following producing method, out of producing methods including the step of the stretching in a laminate state and the step of the dyeing, since the laminate can be stretched into a high stretch ratio to improve the resultant in polarizing performance: a producing method including the step of stretching the laminate in an aqueous solution of boric acid, as is described in a pamphlet of WO 2010/100917, or a specification of PCT/JP 2010/001460 or Japanese Patent Application No. 2010-269002 or 2010-263692. The thin polarizing membranes are in particular preferably thin polarizing membranes each yielded by a producing method including the step of stretching the laminate supplementally in the air before the stretching in the aqueous solution of boric acid, as is described in a specification of Japanese Patent Application No. 2010-269002 or 2010-263692.

The transparent protective film is preferably a film excellent in transparency, mechanical strength, thermal stability, water blocking performance, isotropy and others. Examples of a material therefor include polyester based polymers, such as polyethylene terephthalate and polyethylene naphthalate, cellulose based polymers such as diacetylcellulose and triacetylcellulose, acrylic polymers such as polymethyl methacrylate, styrene based polymers such as polystyrene and acrylonitrile/styrene copolymer (AS resin), and polycarbonate based polymers. Other examples of the polymer which the transparent protective film is made of include polyethylene, polypropylene, polyolefins each having a cyclic or norbornene structure, polyolefin based polymers such as ethylene/propylene copolymer, vinyl chloride based polymers, amide based polymers such as nylon and aromatic polyamide, imide based polymers, sulfone based polymers, polyethersulfone based polymers, polyetheretherketone based polymers, polyphenylene sulfide based polymers, vinyl alcohol based polymers, vinylidene chloride based polymers, vinyl butyral based polymers, arylate based polymers, polyoxymethylene based polymers, and epoxy based polymers; and any blend composed of two or more of these polymers. The transparent protective film may contain one or more appropriate dopants selected at will. Examples of the dopant(s) include an ultraviolet absorbent, an antioxidant, a lubricant, a plasticizer, a release agent, a coloring preventive, a flame retardant, a nucleating agent, an antistatic agent, a pigment and a colorant. The content of one or more of the above-mentioned thermoplastic resins in the transparent protective film is preferably from 50 to 100%, more preferably from 50 to 99%, even more preferably from 60 to 98%, in particular preferably from 70 to 97% by weight. If the content of the thermoplastic resin(s) in the transparent protective film is 50% or less by weight, it is feared that the transparent protective film cannot sufficiently express high transparency and other properties which the thermoplastic resin(s) originally has/have.

The Tg (glass transition temperature) of the transparent protective film is preferably 115° C. or higher, more preferably 120° C. or higher, even more preferably 125° C. or higher, in particular preferably 130° C. or higher. When the Tg is 115° C. or higher, the polarizing film can become excellent in endurance. The upper limit value of the Tg of the transparent protective film is not particularly limited, and is preferably 170° C. or lower from the viewpoint of the shapability thereof.

The polarizer and the transparent protective film may each be subjected to a surface modifying treatment before the application of the curable resin composition thereonto. In particular, about the polarizer, before the application or bonding of the curable resin composition, it is preferred to subject the surface of the polarizer to a surface modifying treatment. Examples of the surface modifying treatment include corona treatment, plasma treatment, and ITRO treatment. The surface modifying treatment is in particular preferably corona treatment. When the surface is subjected to corona treatment, polar functional groups such as carbonyl and amino groups are produced in the polarizer surface to improve this surface and the curable resin layer in adhesiveness therebetween. Moreover, the resultant ashing effect causes the contaminants on the surface to be removed, and decreases irregularities in the surface, so that a polarizing film excellent in external appearance properties can be produced.

When the polarizer is subjected to surface modifying treatment, the treatment is preferably conducted to set the surface roughness (Ra) of the surface of the polarizer to 0.6 nm or more. The surface roughness (Ra) is preferably 0.8 nm or more, even more preferably 1 nm or more. By setting the surface roughness (Ra) to 0.6 nm or more, the polarizer can be satisfactorily transported also when surfaces of the polarizer are brought into contact with guide rolls in a process for producing the polarizing film. If the surface roughness (Ra) becomes too large, the polarizer becomes bad in hot water resistance. Thus, the surface roughness (Ra) is preferably 10 nm or less, more preferably 5 nm or less.

In the measurement of the surface roughness (Ra), the arithmetic average roughness (average value of the heights of irregularities of the surfaces) of the polarizer is a parameter representing the surface roughness thereof. In the measurement of the surface roughness (Ra), the surface roughness (Ra) is a value measured using an atomic force microscope (AFM), Nanoscope IV, manufactured by Veeco Instruments Inc. in a tapping mode. A cantilever used therefor is, for example, a metrology probe, Tap 300 (RTESP type). The measuring area is an area of 1 μm square.

An optical film, in particular, a polarizing film according to the present invention can be produced by the following producing method:

A method for producing an optical film including a polyvinyl alcohol based polarizer and a cured product layer that is on at least one surface of this polarizer and that is yielded by curing a curable resin composition for optical films; the curable resin composition being a composition for optical films including an active-energy-ray-curable component (A) and a chlorinated polyolefin (B); and the method including an applying step of applying the curable resin composition for optical films directly onto the at least one surface of the polyvinyl alcohol based polarizer, and a curing step of radiating an active energy ray to the resultant from a polyvinyl-alcohol-based-polarizer-surface side of the resultant or a side of the resultant onto which the curable resin composition for optical films is applied, so as to cure the curable resin composition for optical films.

The means for the application of the curable resin composition for optical films is appropriately selected in accordance with the viscosity of the curable resin composition, and a target thickness of the resultant layer. Examples of the means include a reverse coater, a (direct, reverse or offset) gravure coater, a bar reverse coater, a roll coater, a die coater, a bar coater, and a rod coater.

When two films are laminated onto each other, it is an ordinary manner to apply an adhesive composition onto a bonding surface of one of the films, and laminate the other onto the surface. However, when adhesive layers are applied, respectively, onto respective bonding surfaces of the two films and then the films are laminated onto each other, a laminated film can be yielded which is excellent in external appearance quality. The method for the application is preferably an afterward-weighing application method. In the present invention, the “afterward-weighing application method” means a method of giving external force to a liquid membrane to remove an excessive liquid thereof to give a predetermined applied-membrane thickness. In the method according to the present invention for producing a polarizing film, rubbish, dust and other alien substances present on the bonding surfaces are scratched off when external force is applied to the liquid membrane made of the curable resin composition. Specific examples of the afterward-weighing application method include gravure roll, forward roll, air-knife, and rod/bar coating methods. In the present invention, the application method is preferably a gravure roll coating method, in which a gravure roll is used, from the viewpoint of the removal precision of the alien substances, the evenness of the thickness of the applied membrane, and others.

Through the curable resin composition applied as described above, a polarizer and a transparent protective film can be bonded to each other. The bonding of the polarizer and the transparent protective film to each other can be attained, using, for example, a roll laminator. The method for laminating protective films, respectively, onto both surfaces of the polarizer is selected form a method of bonding one of the protective films to the polarizer, and then bonding the other further to the polarizer, and a method of bonding the two protective films simultaneously to the polarizer. Preferred is the adoption of the former method, that is, the method of bonding one of the protective films to the polarizer, and then bonding the other further to the polarizer since the former method makes it possible to make a remarkable decrease in the quantity of involved-air-bubbles generated at the time of the bonding.

The active energy ray used in the curing step can be roughly classified into electron beam curability, ultraviolet curability or visible ray curability. In the present invention, active energy rays having a wavelength in the range of 10 nm or more, and less than 380 nm are referred to as ultraviolet rays, and active energy rays having a wavelength in the range of 380 to 800 nm are referred to as visible rays. In the production, for producing a polarizing film, according to the present invention, it is particularly preferred to use visible rays of 380 to 450 nm wavelengths.

About the polarizing film according to the present invention, its adhesive layer is formed by applying the above-defined curable resin composition for optical films directly onto a polarizer, optionally laminating/bonding a transparent protective film onto the surface of the polarizer onto which the curable resin composition for optical films has been applied, and then radiating an active energy ray (for example, an electron beam, ultraviolet ray or visible ray) thereto to cure the active-energy-ray-curable resin composition. The direction along which the active energy ray (for example, an electron beam, ultraviolet ray or visible ray) is radiated may be any appropriate direction. Preferably, the ray is radiated to the workpiece from the the surface side of the polarizer onto which the curable resin composition for optical films has been applied, or from the transparent protective film side of the polarizer. When the ray is radiated to the workpiece from the polarizer side thereof, the polarizer may be deteriorated by the active energy ray (for example, an electron beam, ultraviolet ray or visible ray).

About the electron beam curability, conditions for radiating the electron beam may be arbitrarily-selected appropriate conditions as far as the conditions are conditions under which the active-energy-ray-curable resin composition for optical films is curable. About the electron beam radiation, for example, the accelerating voltage is preferably from 5 to 300 kV, more preferably from 10 to 250 kV. If the accelerating voltage is less than 5 kV, the electron beam may not reach the curable resin composition so that the composition may not be unfavorably cured sufficiently. If the accelerating voltage is more than 300 kV, the penetrating power of the beam into a sample is too strong, so that the beam may unfavorably damage its transparent protective film or polarizer. The radiation ray quantity thereof is from 5 to 100 kGy, more preferably from 10 to 75 kGy. If the radiation ray quantity is less than 5 kGy, the curable resin composition is insufficiently cured. If the quantity is more than 100 kGy, the transparent protective film or the polarizer is damaged, so that the resultant optical film is lowered in mechanical strength or yellowed not to gain predetermined optical properties.

The electron beam radiation is usually performed in an inert gas. If necessary, the radiation may be performed in the atmospheric air or under conditions that a small amount of oxygen is introduced into an inert gas. An appropriate introduction of oxygen dares to cause oxygen blocking in a surface of the transparent protective film onto which the electron beam is to be initially radiated, so that the beam can be prevented from damaging the transparent protective film to radiate the electron beam effectively only to the adhesive although this matter depends on the material of the transparent protective film.

In the method according to the present invention for producing a polarizing film, it is preferred to use, as active energy rays, rays including visible rays having wavelengths ranging from 380 to 450 nm, particularly, active energy rays in which the radiation quantity of visible rays having wavelengths ranging from 380 to 450 nm is the largest. When a transparent protective film to which ultraviolet ray absorbing power is given (ultraviolet non-transmissible type transparent protective film) is used about ultraviolet curability or visible ray curability, the transparent protective film absorbs light rays having wavelengths shorter than about 380 nm; thus, the light rays having wavelengths shorter than 380 nm do not reach the active-energy-ray-curable resin composition not to contribute to a polymerization reaction of the composition. Furthermore, the light rays having wavelengths shorter than 380 nm, which are absorbed by the transparent protective film, are converted to heat, so that the transparent protective film itself generates heat. The heat causes defects of the polarizing film, such as a curling or wrinkles of the film. Thus, in the case of adopting, in the present invention, ultraviolet curability or visible ray curability, it is preferred to use, as an active energy ray generating device, a device which does not emit light rays shorter than 380 nm. More specifically, the following ratio is preferably from 100/0 to 100/50, more preferably from 100/0 to 100/40: the ratio of the integrated illuminance of light rays having a wavelength range from 380 to 440 mm to that of light rays having a wavelength range from 250 to 370 nm. For the active energy ray related to the present invention, preferred is a gallium sealed metal halide lamp, or an LED light source emitting light rays having a wavelength range from 380 to 440 nm. Alternatively, a light source including ultraviolet rays and visible rays is usable, examples of which include a low pressure mercury lamp, a middle pressure mercury lamp, a high pressure mercury lamp, a super high pressure mercury lamp, an incandescent lamp, a xenon lamp, a halogen lamp, a carbon arc lamp, a metal halide lamp, a fluorescent lamp, a tungsten lamp, a gallium lamp, an excimer laser, and sunlight. It is also allowable to use light rays about which a bandpass filter is used to block ultraviolet rays having wavelengths shorter than 380 nm. In order to heighten the adhesive performance of the adhesive layer between the polarizer and the transparent protective film, and simultaneously prevent the polarizing film from being curled, it is preferred to use an active energy ray obtained by using a gallium sealed metal halide lamp and further passing light therefrom through a bandpass filter which can block light rays having wavelengths shorter than 380 nm, or to use an active energy ray having a wavelength of 405 nm, which is obtained by using an LED light source.

The active-energy-ray-curable resin composition according to the present invention is favorably usable, particularly, when an adhesive layer is formed for bonding a polarizer to a transparent protective film about which the transmittance of light rays having a wavelength of 365 nm is less than 5%. At this time, the active-energy-ray-curable resin composition according to the invention may include a photopolymerization initiator of the general formula (2); in this case, by radiating ultraviolet rays to the composition across the transparent protective film having UV absorbing power, this composition can be cured to form an adhesive layer. Thus, also in a polarizing film in which transparent protective films having UV absorbing power are laminated, respectively, onto two surfaces of a polarizer, its adhesive layers can be cured. Naturally, however, also in a polarizing film in which a transparent protective film having no UV absorbing power is laminated, its adhesive layers can be cured. The wording “transparent protective film having UV absorbing power” means a transparent protective film about which the transmittance of a light ray having a wavelength of 380 nm is less than 10%.

The method for giving UV absorbing power to a transparent protective film may be a method of incorporating an ultraviolet absorbent into the transparent protective film, or a method of laminating a surface treatment layer containing an ultraviolet absorbent onto a surface of the transparent protective film.

Specific examples of the ultraviolet absorbent include oxybenzophenone based compounds, benzotriazole based compounds, salicylate based compounds, benzophenone based compounds, cyanoacrylate based compounds, nickel complex salt type compounds, and triazine based compounds, which are known in the prior art.

About ultraviolet curability or visible ray curability, it is preferred to heat the curable resin composition for optical films before the ultraviolet-ray- or visible-ray-radiation (pre-radiation heating). In this case, the composition is heated preferably to 40° C. or higher, more preferably to 50° C. or higher. It is also preferred to heat the curable resin composition for optical films after the ultraviolet-ray- or visible-ray-radiation (post-radiation heating). In this case, the composition is heated preferably to 40° C. or higher, more preferably to 50° C. or higher.

When the polarizing film according to the present invention is produced in a continuous line, the line speed, which depends on the curing period of the curable resin composition, is preferably from 5 to 100 m/min., more preferably from 10 to 50 m/min., even more preferably from 20 to 30 m/min. If the line speed is too small, the producing system is small in producing performance, or the transparent protective film is excessively damaged, so that no polarizing film that can endure an endurance test or the like can be produced. If the line speed is too large, the curable resin composition is insufficiently cured so that the composition may not gain a target adhesion.

When put into practical use, the polarizing film of the present invention is usable in the form of an optical film in which the polarizing film is laminated onto another optical layer. The optical layer is not particularly limited. Examples of the optical film include a reflector, a transreflector, retardation plates (for example, a wavelength plate such as a half wavelength plate and a quarter wavelength plate), a viewing angle compensation film, and other layers usable to form a liquid crystal display or the like. These layers may be used singly or in the form of two or more layers thereof. The polarizing film of the present invention is in particular preferably a reflection type polarizing film or transreflectve type polarizing film in which a reflector or a transreflector is further laminated on any polarizing film of the invention, an elliptically or circularly polarizing film in which a retardation plate is further laminated on the polarizing film, a wide viewing angle polarizing film in which a viewing angle compensation film is further laminated on the polarizing film, or a polarizing film in which a brightness enhancement film is further laminated on the polarizing film.

An optical film in which optical layers as described above are laminated onto the polarizing film may be formed in such a manner that the layers are successively and separately laminated onto each other in a process for producing, for example, a liquid crystal display. An optical film prepared by laminating the layers beforehand onto each other is excellent in quality stability, fabricating workability and others to have an advantage of improving a process for producing, for example, a liquid crystal display. For the laminating, a pressure-sensitive-adhesive layer or any other appropriate adhesive means may be used. In the adhesion of the polarizing film or the other optical film(s), its or their optical axis may be adjusted to have an appropriate location angle in accordance with, for example, a target retardation property.

In the above-mentioned polarizing film or an optical film in which at least one polarizing film as described above is laminated, a pressure-sensitive-adhesive layer may be laid for allowing the film to adhere to a different member such as a liquid crystal cell. A pressure-sensitive adhesive agent which forms the pressure-sensitive-adhesive layer is not particularly limited. This agent may be appropriately selected from the following to be used: pressure-sensitive adhesive agents each containing, as a base polymer thereof, for example, acrylic polymer, silicone based polymer, polyester, polyurethane, polyamide, polyether, fluorine-containing polymer, or rubbery polymer. The pressure-sensitive adhesive agent is in particular preferably an acrylic pressure-sensitive adhesive, or any other pressure-sensitive adhesive that is excellent in optical transparency, and shows pressure-sensitive adhesive properties of appropriate wettability, cohesive property and adhesion to be excellent in weather resistance, heat resistance and others.

The pressure-sensitive-adhesive layer may be laid onto a single surface or each surface of the polarizing film or the optical film as a covering layer different therefrom in, for example, composition or species. When pressure-sensitive-adhesive layers are laid, respectively, onto both surfaces of the polarizing film or optical film, these layers may be rendered pressure-sensitive-adhesive layers different from each other in, for example, composition, species or thickness on the front and rear side of the polarizing film or optical film. The thickness of (each of) the pressure-sensitive-adhesive layer(s) may be appropriately decided in accordance with, for example, the use purpose and adhering strength thereof. The thickness is generally from 1 to 100 μm, preferably from 5 to 30 μm, in particular preferably from 10 to 20 μm.

A separator is temporarily bonded to a naked surface of the pressure-sensitive-adhesive layer to cover the surface in order to attain the prevention of the pollution of the surface, and other purposes until the polarizing film is put into practical use. This coverage makes it possible to prevent any object or person from contacting the pressure-sensitive-adhesive layer in the state that the polarizing film is ordinarily handled. The separator may be an appropriate separator according to conventional techniques except the above-mentioned thickness conditions. The separator may be an appropriate therein flat piece yielded according to the prior art. An example thereof is a plastic film, a rubber sheet, a paper, cloth or nonwoven cloth piece, a net, a foamed sheet or a metal foil piece; a laminated body of such therein flat pieces; or a product in which such a thin flat piece is optionally subjected to coating treatment with an appropriate release agent, such as a silicone type, long-chain alkyl type or fluorine-containing type agent, or molybdenum sulfide.

The polarizing film or optical film of the present invention is preferably usable to form various devices such as a liquid crystal display. The formation of the liquid crystal display may be attained in accordance with the prior art. In other words, any liquid crystal display is generally formed, for example, by fabricating appropriately a liquid crystal cell, a polarizing film or optical film, an optional lighting system, and other constituent parts, and then integrating a driving circuit into the resultant. In the present invention, a method for forming a liquid crystal display is not particularly limited except that the polarizing film or optical film according to the invention is used. Thus, the method is substantially according to the prior art. A liquid crystal cell therefor may be also of any type, such as a TN type, STN type or n type.

An appropriate liquid crystal display may be formed, examples of the display including a liquid crystal display in which a polarizing film or optical film is arranged onto a single side or each of two sides of a liquid crystal cell, and a liquid crystal display in which a backlight or reflector is used as a lighting system. In this case, the polarizing film or optical film according to the present invention can be set on the single side or each of the two sides of the liquid crystal cell. When polarizing films or optical films are set up, respectively, on the two sides, these may be the same as or different from each other. When the liquid crystal display is formed, one or more appropriate components may be further arranged, at one or more appropriate positions of the display, in the form of one or more layers. Examples of the component(s) include a diffusing plate, an anti-glare layer, an anti-reflection film, a protective plate, a prism array, a lens array sheet, a light diffusing plate, and a backlight.

### EXAMPLES

Hereinafter, working examples of the present invention will be described. However, embodiments of the invention are not limited to these examples.

(Preparation of Curable Resin Compositions)

A stirring device was used to stir 90 parts by weight of 1,9-nonanediol diacrylate (“LIGHT ACRYLATE 1,9ND-A” manufactured by Kyoeisha Chemical Co., Ltd.), 10 parts by weight of a chlorinated polyolefin (“SUPERCHLON 814HS (content by percentage of chlorine: 41% by weight)” manufactured by Nippon Paper Chemicals Co., Ltd.), and 3 parts by weight of a photopolymerization initiator (“IRGACURE 907” manufactured by the company BASF) for 3 hours. In this way, a curable resin composition A was yielded. In the curable resin composition A, the ratio by weight of 1,9-nonanediol diacrylate, which is an active-energy-ray-curable component (A), to the “SUPERCHLON 814HS”, which is a chlorinated polyolefin (B), was 100/11.

A stirring device was used to stir 100 parts by weight of 1,9-nonanediol diacrylate (“LIGHT ACRYLATE 1,9ND-A” manufactured by Kyoeisha Chemical Co., Ltd.), and 3 parts by weight of the photopolymerization initiator (“IRGACURE 907” manufactured by the company BASF) for 3 hours. In this way, a curable resin composition B was yielded.

A stirring device was used to stir 75 parts by weight of 1,9-nonanediol diacrylate (“LIGHT ACRYLATE 1,9ND-A” manufactured by Kyoeisha Chemical Co., Ltd.), 25 parts by weight of the chlorinated polyolefin (“SUPERCHLON 814HS (content by percentage of chlorine: 41% by weight)” manufactured by Nippon Paper Chemicals Co., Ltd.), and 3 parts by weight of the photopolymerization initiator (“IRGACURE 907” manufactured by the company BASF) for 3 hours. In this way, a curable resin composition C was yielded. In the curable resin composition C, the ratio by weight of 1,9-nonanediol diacrylate, which is an active-energy-ray-curable component (A), to the “SUPERCHLON 814HS”, which is a chlorinated polyolefin (B), was 100/33.

A stirring device was used to stir 99 parts by weight of 1,9-nonanediol diacrylate (“LIGHT ACRYLATE 1,9ND-A” manufactured by Kyoeisha Chemical Co., Ltd.), 1 part by weight of a chlorinated polyolefin (“SUPERCHLON 3228S (content by percentage of chlorine: 28% by weight)” manufactured by Nippon Paper Chemicals Co., Ltd.), and 3 parts by weight of the photopolymerization initiator (“IRGACURE 907” manufactured by the company BASF) for 3 hours. In this way, a curable resin composition D was yielded. In the curable resin composition D, the ratio by weight of 1,9-nonanediol diacrylate, which is an active-energy-ray-curable component (A), to the “SUPERCHLON 3228S”, which is a chlorinated polyolefin (B), was 100/1.

A stirring device was used to stir 99.9 parts by weight of 1,9-nonanediol diacrylate (“LIGHT ACRYLATE 1,9ND-A” manufactured by Kyoeisha Chemical Co., Ltd.), 0.1 parts by weight of the chlorinated polyolefin (“HARDLEN CY-9124P” (content by percentage of chlorine: 24% by weight) manufactured by Toyobo Co., Ltd.), and 3 parts by weight of the photopolymerization initiator (“IRGACURE 907” manufactured by the company BASF) for 3 hours. In this way, a curable resin composition E was yielded. In the curable resin composition E, the ratio by weight of 1,9-nonanediol diacrylate, which is an active-energy-ray-curable component (A), to the “HARDLEN CY-9124P”, which is a chlorinated polyolefin (B), was 100/0.1.

(Production of Polarizer)

As a resin substrate, prepared was an amorphous polyethylene terephthalate film (hereinafter abbreviated to a PET film) having a thickness of 100 μm and having 7% by mole of isophthalic acid units showing Tg of 75° C. Corona treatment (58 W/m²/min.) was applied to the front surface of this film.

Prepared was a PVA (average polymerization degree: 4200, and saponification degree: 99.2% by mole) to which the following was added in a proportion of 1% by weight: an acetoacetyl-modified PVA (trade name: GOHSEFIMER Z200, manufactured by Nippon Synthetic Chemical Industry Co., Ltd.; average polymerization degree: 1200, saponification degree: 98.5% or more by mole, and acetoacetylation degree: 5%). An aqueous solution of the PVA based resins was then prepared to give a concentration of 5.5% by weight. This aqueous solution was applied onto the corona-treatment-applied surface of the resin substrate to give a film thickness of 9 μm after the film would be dried. The resultant was dried in an atmosphere of 60° C. temperature by hot wind for 10 minutes to form a PVA based resin layer of 9 μm thickness on the resin substrate. In this way, a laminate was produced.

The resultant laminate was initially stretched 1.8 times at 130° C. in the air (in-air auxiliary stretching).

Next, the laminate was immersed in an aqueous solution of boric acid which had a liquid temperature of 30° C. for 30 seconds to make the PVA based resin layer insoluble. About the aqueous solution of boric acid in this step, the boric acid content therein was set to 3 parts by weight for 100 parts by weight of water.

Next, the laminate was immersed in a dyeing solution having a liquid temperature of 30° C. and containing iodine and potassium iodide for a period selected at will to set the single-body-transmittance of the resultant polarizing film to a value of 40 to 44%. In this way, the laminate was dyed. In the dyeing solution, water was used as a solvent to set the iodine concentration into the range of 0.1 to 0.4% by weight, and set the potassium iodide concentration into the range of 0.7 to 2.8% by weight. The ratio by concentration of iodide to potassium iodine was set to 1/7.

Next, the laminate was immersed in an aqueous solution of boric acid, the temperature of which was 30° C., for 60 seconds to apply crosslinking treatment to the iodine-adsorbed PVA resin layer. In the aqueous solution of boric acid in this step, the boric acid content was set to 3 parts by weight for 100 parts by weight of water, and the potassium iodide content was set to 3 parts by weight for 100 parts by weight of water.

Furthermore, at a stretching temperature of 70° C. in an aqueous solution of boric acid, the laminate was stretched 3.05 times in the same direction as in the above-mentioned in-air auxiliary stretching (final stretch ratio: 5.50). In the aqueous solution of boric acid in this step, the boric acid content was set to 4 parts by weight for 100 parts by weight of water, and the potassium iodide content was set to 5 parts by weight for 100 parts by weight of water.

Next, the laminate was cleaned with an aqueous solution in which the potassium iodide content was 4 parts by weight for 100 parts by weight of water, and then dried by hot wind of 60° C. temperature to yield each laminate of the PET film and a polarizing film of 3.7 μm thickness.

(Transparent Protective Film)

A biaxial kneading machine was used to mix 100 parts by weight of an imidized MS resin described in Production Example 1 in JP-A-2010-284840, and 0.62 parts by weight of a triazine type ultraviolet absorbent (trade name: T-712, manufactured by Adeka Corp.) at 220° C. to produce resin pellets. The resultant resin pellets were dried at 100.5 kPa and 100° C. for 12 hours, and extruded from a uniaxial extruder through its T die at a dice temperature of 270° C. to be shaped into a film form (thickness: 160 μm). Furthermore, the film was stretched (into a thickness of 80 μm) in a transporting direction thereof in an atmosphere of 150° C. temperature. Next, an easily-bondable adhesive containing an aqueous urethane resin was painted thereonto, and then the resultant was stretched in a direction orthogonal to the film-transporting direction in an atmosphere of 150° C. temperature to yield each transparent acrylic film of 40 μm thickness (moisture permeability: 58 g/m²/24-h).

<Humidifying Endurance Test>

The yielded polarizing film was put in an environment of 85° C. temperature and 85% RH for 250 hours. A photospectrometer with an integrating sphere (product V7100 manufactured by JASCO corp.) was used to measure the respective polarization degrees of the film before and after the film was put therein. A variation ΔP (%) of the polarization degree was gained in accordance with the following: ΔP (%)=|(polarization degree (%) before the putting)−(polarization degree (%) after the putting)|. It was determined that as polarizing films are smaller in polarization degree variation ΔP (%), the polarizing films are better in optical endurance in a severe humidifying environment.

### Example 1

One of the transparent acrylic films was bonded to (the PET-film-opposite-side-surface) of one of the resultant polarizing films through the curable resin composition A. Specifically, the curable resin composition A was applied onto the transparent acrylic film to give a thickness of 1.0 μm, using an MCD coater (manufactured by Sealing resin Machinery Co., Ltd.; cell shape: honeycomb; the number of its gravure roll lines: 1000 per inch, and rotating speed: 140% of the speed of the lines). A rolling machine was then used to bond the resultant layer to the film. The line speed for the bonding was set to 25 m/min.

Thereafter, the above-mentioned visible rays were radiated to the resultant from the acrylic film side thereof to cure the curable resin composition. Next, the resultant was dried by hot wind at 70° C. for 3 minutes to yield a polarizing film.

After the above-defined endurance test, the polarization degree variation ΔP thereof was 0.02%.

### Comparative Example 1

The same operations were made in the same way as in Example 1 except that the curable resin composition A was changed to the active-energy-ray-curable resin composition B.

After the endurance test, the polarization degree variation ΔP thereof was 0.21%.

### Example 2

The same operations were made in the same way as in Example 1 except that the curable resin composition A was changed to the active-energy-ray-curable resin composition C.

After the above-defined endurance test, the polarization degree variation ΔP thereof was 0.02%.

### Example 3

The same operations were made in the same way as in Example 1 except that the curable resin composition A was changed to the active-energy-ray-curable resin composition D.

After the endurance test, the polarization degree variation ΔP thereof was 0.11%.

### Example 4

The same operations were made in the same way as in Example 1 except that the curable resin composition A was changed to the active-energy-ray-curable resin composition E.

After the endurance test, the polarization degree variation ΔP thereof was 0.16%.

TABLE 1

| | | | | Comparative | | | |
|---|---|---|---|---|---|---|---|
| | | | Example 1 | Example 1 | Example 2 | Example 3 | Example 4 |
| Curable resin | Composition | | Composition | Composition | Composition | Composition | Composition |
| composition | name | | A | B | C | D | E |
| for optical | Active-energy-ray- | 1,9-Nonanediol | 90 | 100 | 75 | 99 | 99.9 |
| films | curable componet (A) | diacrylate | | | | | |
| | Chlorinated | SUPERCHLON 814HS | 10 | | 25 | | |
| | polyolefin (B) | (chlorine content: 41%) | | | | | |
| | | SUPERCHLON 3228S | | | | 1 | |
| | | (chlorine content: 28%) | | | | | |
| | | HARDLEN CY-9124P | | | | | 0.1 |
| | | (chlorine content: 24%) | | | | | |
| | Other componet | IRGACURE 907 | 3 | 3 | 3 | 3 | 3 |

| | | | | | |
|---|---|---|---|---|---|
| Ratio by weight of active-energy-ray-curable | 100:1.1 | 100:0 | 100:33 | 100:1 | 100:0.1 |
| componet (A) to chlorinated polyolefin (B) | | | | | |

| | | | | | |
|---|---|---|---|---|---|
| Polarization degree variation ΔP (%) | 0.02% | 0.21% | 0.02% | 0.11% | 0.16% |

It is understood from the results of Examples 1 to 4 and Comparative Example 1 described above that when a curable resin composition for polarizing films includes an active-energy-ray-curable component (A) and a chlorinated polyolefin (B), a polarizing film yielded by laminating a transparent protective film onto a polarizer through a cured product layer of the composition is controlled to be remarkably lowered in polarization degree variation, so that the polarizing film is excellent in optical endurance.

1. A curable resin composition for optical films, comprising an active-energy-ray-curable component (A) and a chlorinated polyolefin (B).

2. The curable resin composition for optical films according to claim 1, wherein the chlorinated polyolefin (B) has a chlorine content of 25 to 50% by weight.

3. The curable resin composition for optical films according to claim 1, wherein a ratio by weight of the active-energy-ray-curable component (A) to the chlorinated polyolefin (B) is from 100/1 to 100/40.

4. An optical film, comprising a polyvinyl alcohol based polarizer, and a cured product layer of a curable resin composition for optical films that comprises an active-energy-ray-curable component (A) and a chlorinated polyolefin (B), the cured product layer being laminated on at least one surface of the polarizer.

5. The optical film according to claim 4, wherein a transparent protective film is laminated over the at least one surface of the polyvinyl alcohol based polarizer to interpose the cured product layer between the one surface and the transparent protective film.

6. The optical film according to claim 4, wherein the cured product layer is laminated on the one surface of the polyvinyl alcohol based polarizer, and a transparent protective film is laminated on/over another surface of the polyvinyl alcohol based polarizer.

7. A method for producing an optical film comprising a polyvinyl alcohol based polarizer and a cured product layer that is on at least one surface of the polyvinyl alcohol based polarizer and that is yielded by curing a curable resin composition for optical films:
the curable resin composition for optical films that comprises an active-energy-ray-curable component (A) and a chlorinated polyolefin (B); and
the method comprising an applying step of applying the curable resin composition for optical films directly onto the at least one surface of the polyvinyl alcohol based polarizer, and
a curing step of radiating an active energy ray to the curable resin composition for optical films from a polyvinyl-alcohol-based-polarizer-surface side or a side onto which the curable resin composition for optical films is applied, so as to cure the curable resin composition for optical films.
